(19) United States
(12) Patent Application Publication
(10) Pub. No.: US 2023/0419283 A1
(43) Pub. Date: Dec. 28, 2023

(54) Systems and Methods for Forming and Operating NFT Marketplace

(71) Applicant: Sutudu LLC, Jersey City, NJ (US)

(72) Inventor: Khoa Le, Jersey City, NJ (US)

(21) Appl. No.: 17/850,374

(22) Filed: Jun. 27, 2022

(51) Int. Cl. G06Q 20/12; G06Q 20/36; G06Q 20/38

(52) U.S. Cl. CPC G06Q 20/1235; G06Q 20/36; G06Q 20/389

(57) ABSTRACT

Systems, apparatuses, and methods to enable the formation and operation of a marketplace for non-fungible tokens. An NFT offered through the marketplace may be associated with underlying content. The underlying content may be one or more of an image, a photograph, an original work of art, a composition, a literary work, a recording, an item of manufacture, a motion picture, or a television program. The system provides a mechanism for multiple parties involved in the creation, production, ownership, distribution, exhibition, and use of content to have payments automatically routed from the appropriate paying party to the appropriate receiving party because of logic executed by a smart contract. This is particularly useful where underlying content may be the subject of different types of distribution, exhibition, and/or licensing agreements depending upon the nature of the content, the relevant intellectual property rights (such as copyrights), and the business model of the relevant industry.

### BACKGROUND

Non-fungible tokens (NFTs) are non-interchangeable units of data stored on a blockchain¹, that can be sold and traded. NFTs may be associated with digital files such as images, photos, videos, audio content, and even original works of art created using graphics tools. Each token is uniquely identifiable and is associated with a particular digital or physical asset (such as a file or a physical object) and typically, a license to use the asset for a specified purpose. An NFT (and, if applicable, the associated license to use, copy, or display the underlying asset) can be traded and sold in an on-line marketplace. The extra-legal nature of NFT trading usually results in an informal exchange of ownership over the asset that has no legal basis for enforcement and may confer little more than the token's use as a status symbol. ¹ A blockchain is a decentralized and distributed digital ledger consisting of records (blocks) and is used to record transactions across multiple computers. One feature of a blockchain is that a block cannot be altered retroactively, without causing an alteration of all subsequent blocks. This allows the participants to verify and audit transactions independently and inexpensively in terms of the resources required. Blockchains allow secure, distributed storage of event and transaction data that is verifiable and resistant to unauthorized usage.

The blocks in a blockchain are interconnected by encrypting data of a previous block in the chain and inserting it into a current block. Each block contains a cryptographic hash of the previous block, a time stamp, and exchange information (such as conditions on when a payment will be transferred, or a condition satisfied—a form of “smart” contract). A blockchain database is managed autonomously using a peer-to-peer network and a distributed timestamping server. New blocks are authenticated by mass collaboration powered by collective self-interest. This approach facilitates workflow and one where participants' uncertainty regarding data security is reduced to an acceptable level, thereby engendering sufficient trust to engage in economic transactions. One reason for this is that the use of a blockchain removes the characteristic of unauthorized reproducibility from a digital asset by confirming that each unit of value was transferred only once, solving the long-standing problem of double spending.

Blockchain-based smart contracts are proposed contracts that can be partially or fully executed or enforced without human interaction. A key feature of smart contracts is that they do not need a trusted third party (such as a trustee) to act as an intermediary between contracting entities. Instead, the blockchain network executes the contract on its own. See Wikipedia entry for Blockchain

Although NETs have some similar characteristics to cryptographic tokens, they differ in that unlike cryptocurrency such as Bitcoin or Ethereum, NFTs are not mutually interchangeable, and so are not fungible. While all bitcoins are equal in value, each NFT may represent a different underlying asset and thus may have a different value. NFTs are created when blockchains concatenate records containing cryptographic hashes-sets of characters that identify a set of data-onto previous records, creating a chain of identifiable data blocks. The cryptographic transaction process ensures the authentication of each digital file by providing a digital signature that tracks NFT ownership. Data links may be part of NFT records, and (for example) may point to details about where the associated content is stored.

Although NFTs have become the subject of great interest and some tokens have become collectibles, effective monetization of NFTs is an area where a reliable approach has not yet been developed. One specific problem with conventional approaches is that the creator of an NFT (who may be an author, artist, musician, or other performer) has little (if any) control over the setting and collection of payments for sales or licensed uses of an NFT. This is a particularly complicated problem when an NFT is linked to a collaborative work, such as a motion picture, television program, or collection of articles.

Conventional NFT marketplaces utilize a single royalty system that is designed for use by a solo artist and is not suitable for use with a collaborative work. Although that single person may then redistribute royalties or other forms of payment received for use of an NFT or its underlying content, all funds are channeled through that person. This can cause problems with regards to prompt payment and payment of the correct amounts for the others involved in a collaborative effort.

Conventional NFT marketplaces have at least two significant disadvantages: (1) they are not designed for and capable of the efficient distribution of payments received for use of an NFT or the underlying content when the content is the result of a collaborative effort; and (2) they are not effective for use with content that may be subject to multiple licensing terms or rights, such as those involving separate royalty payments for distribution, exhibiting, viewing, performing, copying, or sub-licensing, as examples.

Systems and methods are needed for enabling more efficient monetization of non-fungible tokens linked to underlying content, particularly where the underlying content is the result of a collaborative effort. Embodiments of the disclosure are directed toward solving these and other problems individually and collectively.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do limit the subject matter disclosed or limit the meaning or scope of the claims. Embodiments disclosed herein are defined by the claims and not by this summary. This summary is a high-level overview of various aspects of one or more embodiments and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification of this patent, to any or all figures or drawings, and to each claim.

In some embodiments, the disclosure is directed to systems, apparatuses, and methods for enabling the efficient formation and operation of a marketplace for NFTs or a similar form of token. In some embodiments, an NFT offered through the marketplace may be “linked” to or associated with underlying content. The underlying content may comprise one or more of an image, a photograph, an original work of art, a composition, a literary work, a recording, an item of manufacture, a motion picture, or a television program, as non-limiting examples.

In general, an embodiment may be implemented as a system and used to define one or more of the following:
A product, service, or item of content produced through a collaborative effort;
A set of entities entitled to a share of revenue generated by the use or licensing of the product, service, or content;
A description of each entity's share and the conditions or terms under which that share is to be paid;
A set of digital wallets, with one wallet being associated with or owned by each entity;
A set of logical operations that determine, based on one or more events or factors, when and in what amounts to distribute a payment to an entity;
   In one embodiment, this set of logical operations may be implemented as a smart contract;
   In one embodiment, this set of logical operations may be implemented as a rule-set;
A user interface to enable an entity to monitor, track, and verify that a payment has been made;
   The interface may include elements or tools to enable an entity to determine what revenue has been generated through use of the product, service, or content associated with the token, and how that revenue has been distributed.

The disclosed NFT marketplace is particularly advantageous for the creation and management of royalties or other forms of payment received for the transfer and use of content resulting from a collaborative effort. In these situations, the disclosed system or platform enables the distribution of payments to each of the collaborators who created or otherwise contributed to the content and does so in a verifiable and unalterable way by use of blockchain technology.

The disclosed system or platform also provides a mechanism for multiple parties that may be involved in the creation, production, ownership, distribution, exhibition, and use of content to have payments automatically routed from the appropriate paying party to the appropriate receiving party because of logic executed by a smart contract. This is particularly useful and efficient where underlying content may be the subject of different types of distribution, exhibition, and/or licensing agreements depending upon the nature of the content, the relevant intellectual property rights (such as copyrights), and the business model of the relevant industry.

The disclosed NFT marketplace and royalty management system allows for collaborative partnerships to form more efficiently and securely from both a workflow and financial perspective. As a non-limiting example, when an artist or other type of content creator uploads their content, they can set royalty amounts for various uses or transfer of rights, and establish digital wallets, one for each collaborator or contributor to the content.

When a sale of the NFT and underlying content occurs, the proceeds may be split according to a determined percentage for each party involved in creating or contributing to the content. If after a sale (or in some cases prior to a sale), the content is distributed, exhibited, or licensed, royalties or other forms of payment may be transferred automatically from a paying entity to a receiving entity or entities by operation/execution of a smart contract. For example, if an NFT sells on a secondary market, a smart contract clause or condition may be activated and operates to automatically distribute the received funds to the respective wallets.

Embodiments are particularly advantageous for the monetization of rights that are specific to an industry or business model. These rights or business models may include, but are not limited to one or more of:
Distribution of content to specific locations, geographic regions, or in specific formats or languages;
Exhibition of content in specific formats, contexts, environments, or using specific methods or technologies;
Licensing of intellectual property or other rights associated with the underlying content, such as for adaptations, derivative works, books, comics, avatars, voice-overs, or animated versions;
Tracking and appropriate distribution of revenue generated from the manufacture and/or assembly of parts, value-added modifications, or a compilation of separate works;
Licensing revenue generated from a product or service that may utilize multiple protected components or elements;
   Patent licensing for a set of patents covering technology implemented in a product or service;
   ASCAP or a similar music or content licensing structure;
Tracking of food production—to track and provide payment to different contributors to production and distribution of food items;
Joint partnerships intended to produce a product or service;
Non-profit organizations—tracking of received/donated funds and how those are spent or distributed; or
In general, for situations of multiple collaborators or contributors to track each portion that is part of a complete product or service and provide data on use/distribution of content or components (numbers, added value, units produced as examples).

Embodiments of the disclosure are directed to systems, apparatuses, and methods for the establishment and management of a NFT marketplace. In one embodiment, and for the example of a collaborative creation of an item of content, this may comprise the following steps, stages, functions, operations, or processes:
Content seller establishes account on marketplace platform;
   The content seller may be a single person, a single person representing others, or a single person representing an entity, as examples;
   The content may be an image, an audio track, a photograph, an original work of art, a composition, a recording, a literary work, a motion picture, or a television program, as examples;
The content seller provides information regarding one or more of:
   An initial sale price for the content;
   A list of the collaborators or co-creators;
      This may include composers, sound engineers, producers, or backing musicians, as examples;
      This may include names/identifiers for each party or entity that is to receive a portion of the sale price and/or royalties;
   How payments or royalties are to be distributed to the collaborators or other participants in creating or marketing the content;
      This is typically expressed as a percentage of available royalties or revenue, although other ways of defining an entity's share may be used;
   Setting a duration for distribution of a royalty or royalties, after which distribution is halted;
   Creating an option for the content creator(s) to allow first time NFT buyers to participate in the royalty distribution automatically as revenue is generated in the future;
   Any relevant licensing conditions or terms that trigger a royalty payment or fee;
      This may include mention of rights conveyed by the sale, rights withheld from the buyer, or rights available for purchase or licensing, as non-limiting examples;
      This is a form of the payment executing logic that may be implemented in the form of a smart contract;
The information provided by the content seller is processed by the platform to generate:
   A token representing the underlying content (“minting” the NFT);
   One or more digital crypto “wallets”, with one wallet for each party or entity that is identified by the content seller;
      Each wallet is in the form of data stored on a blockchain and may be protected by an identifier associated with each party or entity;
   A smart contract or other form of self-executing logic (such as a set of automatically triggered events), with each royalty payment or other event defined by a rule or condition and a result or outcome. The self-executing logic may automatically trigger events such as one or more of:
      Payment for the sale of an NFT;
      Payment for the licensing of a right or rights to the underlying content of the NFT;
         Depending upon the type of content and/or business model of a relevant industry, this may include one or more of a license to distribute the content in a market, geographical region, or location, to exhibit the content in a market, geographical location, or type of setting, to sub-license use of the content or use in a specific format, as examples;
      Distribution of a portion of the payment for the sale or licensing of a right to one or more of the identified persons, entities, or wallets;
   A record or records stored on the blockchain of the payments/royalties received, the parties or entities to which the payments/royalties have been distributed, and the rights to the underlying content that have been licensed;
Creation of a user interface or dashboard for each category of possible users—this may include NFT sellers, performers, content financers, content distributors, or content exhibitors, as non-limiting examples;
   Each user interface or dashboard may include elements or tools to enable the user to:
      browse available content;
      select desired content for purchase or licensing;
      in some cases, preview selected content;
      access pricing for the content;
      submit a “bid” or offer for rights to the content or for a specific right;
      access reports to analyze current or expected royalty streams, as an example;
      report inappropriate content; or
      determine which NFTs have been created with the option of participating in royalties for a first-time buyer.

In one embodiment, the disclosure is directed to a system for the establishment and management of a NFT marketplace. The system may include a set of computer-executable instructions, a memory or data storage element containing the set of instructions, and an electronic processor or co-processors. When executed by the processor or co-processors, the instructions cause the processor or co-processors (or a device of which they are part) to perform a set of operations that implement an embodiment of the disclosed method or methods.

In one embodiment, the disclosure is directed to a set of computer-executable instructions, wherein when the set of instructions are executed by an electronic processor or co-processors, the processor or co-processors (or a device of which they are part) perform a set of operations that implement an embodiment of the disclosed method or methods.

In some embodiments, the systems and methods described herein may be provided (in whole or in part) through a SaaS or multi-tenant platform. The platform provides access to multiple entities, each with a separate account and associated data storage. Each account may correspond to a content creator, a content owner, a content distributor, a content exhibitor, or a group of such entities, for example. Each account may access one or more services, a set of which are instantiated in their account, and which implement one or more of the methods or functions described herein.

Other objects and advantages of the systems, apparatuses, and methods disclosed will be apparent to one of ordinary skill in the art upon review of the detailed description and the included figures. Throughout the drawings, identical reference characters and descriptions indicate similar, but not necessarily identical, elements. While the embodiments disclosed or described herein are susceptible to various modifications and alternative forms, specific embodiments are shown byway of example in the drawings and will be described in detail herein. However, the embodiments are not intended to be limited to the exemplary or specific forms described. Rather, the disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1 is a flowchart or flow diagram illustrating a method or process for establishing and managing a NFT marketplace for NFTs and the associated content, in accordance with one or more embodiments of the systems and methods disclosed herein;

FIG. 2 is a flow diagram illustrating a process, method, function, or operation for creating a NFT, in accordance with one or more embodiments of the systems and methods disclosed herein;

FIG. 3 is a flow diagram illustrating a process, method, function, or operation for using an NFT as part of a purchase, in accordance with one or more embodiments of the systems and methods disclosed herein;

FIG. 4 is a diagram illustrating elements or components and concepts that may be present in a computing device, server, or system configured to implement a method, process, function, or operation that may be used in implementing one or more embodiments of the systems and methods disclosed herein;

FIGS. 5-7 are diagrams illustrating an architecture for a multi-tenant or SaaS platform that may be used in implementing one or more embodiments of the systems and methods disclosed herein;

FIG. 8(a) is a diagram illustrating a business model currently utilized in the film or similar industry for the sale of content (such as a film or television program);

FIG. 8(b) is a diagram illustrating the flow of revenue in the business model of FIG. 8(a);

FIG. 9(a) is a diagram illustrating a corresponding business model to that illustrated in FIG. 8(a), when implemented using an embodiment of the systems and methods disclosed herein;

FIG. 9(b) is a diagram illustrating the flow of revenue in the business model of FIG. 9(a);

FIG. 10 is a diagram illustrating the flow of revenue for an acquisition and that is currently utilized in the film or similar industry;

FIG. 11 is a diagram illustrating the flow of revenue for an acquisition when implemented using an embodiment of the systems and methods disclosed herein;

FIG. 12(a) is a diagram illustrating a business model currently utilized in the music or similar industry for the sale of content;

FIG. 12(b) is a diagram illustrating the flow of revenue in the business model of FIG. 12(a) for a public performance of a composition;

FIG. 13 is a diagram illustrating the flow of revenue for a public performance of a composition when implemented using an embodiment of the systems and methods disclosed herein;

FIG. 14 is a diagram illustrating the flow of revenue in the business model of FIG. 12(a) for a public performance of a composition that includes a recording of the performance;

FIG. 15 is a diagram illustrating the flow of revenue for a public performance of a composition that includes a recording of the performance when implemented using an embodiment of the systems and methods disclosed herein;

FIG. 16 is a diagram illustrating the flow of revenue in the business model of FIG. 12(a) for a reproduction of a recording of a performance;

FIG. 17 is a diagram illustrating the flow of revenue for a reproduction of a recording of a performance when implemented using an embodiment of the systems and methods disclosed herein;

FIG. 18 is a diagram illustrating the flow of revenue in the business model of FIG. 12(a) for a sync or master use example;

FIG. 19 is a diagram illustrating the flow of revenue for a sync or master use when implemented using an embodiment of the systems and methods disclosed herein;

FIG. 20 is a diagram illustrating the flow of revenue in the business model of FIG. 12(a) for the composer of a composition in a situation where their composition is the subject of a recording distributed via on-demand streaming or the sale of a physical or digital copy of a recording;

FIG. 21 is a diagram illustrating the flow of revenue for the composer of a composition when implemented using an embodiment of the systems and methods disclosed herein;

FIG. 22 is a diagram illustrating the flow of revenue to the composer or songwriter in the business model of FIG. 12(a) for a sync or master use;

FIG. 23 is a diagram illustrating the flow of revenue to the composers for a sync or master use when implemented using an embodiment of the systems and methods disclosed herein;

FIG. 24 is a diagram illustrating the flow of revenue for a partnership business model using a conventional revenue distribution approach;

FIG. 25 is a diagram illustrating the flow of revenue for a partnership business model when implemented using an embodiment of the systems and methods disclosed herein;

FIG. 26 is diagram illustrating the flow of revenue for a purchase of a product (in the example, an automobile) using a conventional revenue distribution approach;

FIG. 27 is a diagram illustrating the flow of revenue for a purchase of a product (in the example, an automobile) when implemented using an embodiment of the systems and methods disclosed herein;

FIG. 28 is diagram illustrating the flow of revenue for a donation of funds to a non-profit organization using a conventional revenue distribution approach; and

FIG. 29 is a diagram illustrating the flow of revenue for a donation of funds to a non-profit organization when implemented using an embodiment of the systems and methods disclosed herein.

Note that the same numbers are used throughout the disclosure and figures to reference like components and features.

### DETAILED DESCRIPTION

The subject matter of embodiments of the disclosure is described herein with specificity to meet statutory requirements, but this description is not intended to limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which show, by way of illustration, example implementations by which the disclosed systems, apparatuses, and methods may be practiced. The disclosed systems, apparatuses, and methods may, however, be embodied in different forms and should not be construed as limited to the embodiments set forth herein; rather, these embodiments are provided so that this disclosure will satisfy the statutory requirements and convey the scope of the disclosed invention(s) to those skilled in the art.

Among other things, embodiments of the disclosure may be implemented in whole or in part as a system or systems, as one or more methods, or as one or more apparatuses or devices. Embodiments may take the form of a hardware implemented embodiment, a software implemented embodiment, or an embodiment combining software and hardware aspects. For example, in some embodiments, one or more of the operations, functions, processes, or methods disclosed herein may be implemented by one or more suitable processing elements (such as a processor, microprocessor, CPU, GPU, TPU, QPU, state machine, or controller, as examples) that is part of a client device, apparatus, server, network element, remote platform (such as a SaaS platform), or other form of computing or data processing system, device, or platform.

The processing element or elements may be programmed with a set of executable instructions (e.g., software instructions), where the instructions may be stored in (or on) a suitable non-transitory data storage element. In some embodiments, one or more of the operations, functions, processes, or methods disclosed herein may be implemented by a specialized form of hardware, such as a programmable gate array, application specific integrated circuit (ASIC), or the like. Note that an embodiment of the disclosed methods may be implemented in the form of an application, a sub-routine that is part of a larger application, a “plug-in”, an extension to the functionality of a data processing system or platform, or other suitable form. The following detailed description is, therefore, not to be taken in a limiting sense.

In some embodiments, the systems and methods described herein may be provided (in whole or in part) through a SaaS or multi-tenant platform. The platform provides access to multiple entities, each with a separate account and associated data storage. Each account may correspond to a content creator, a content owner, a content distributor, a content exhibitor, or a group of such entities, for example. Each account may access one or more services, a set of which are instantiated in their account, and which implement one or more of the methods or functions described herein.

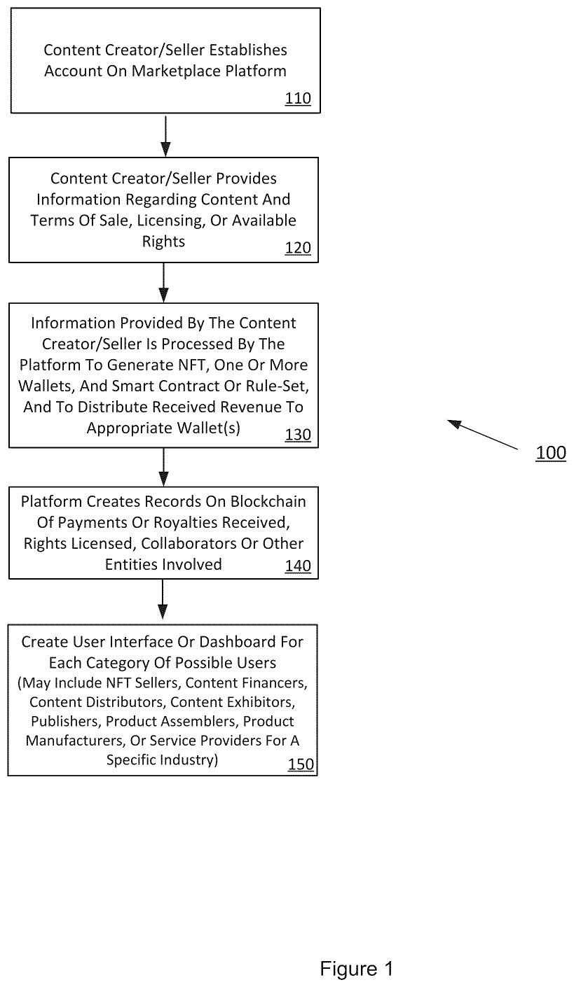

Embodiments of the systems, apparatuses, and methods disclosed herein are directed to implementations of a marketplace for the creation, management, and distribution of revenue obtained from content-backed non-fungible tokens (NFTs). In some embodiments, this is achieved by a process flow that may include the following steps, stages, processes, methods, operations, or functions as described with reference to FIG. 1, which is a flowchart or flow diagram illustrating a method or process 100 for creating a NFT from a collaboratively produced item of content and managing the distribution of revenue generated from the sale, distribution, exhibition, licensing, or other use of the content.

Although the embodiment described with reference to FIG. 1 is most closely related to the creation of a NFT associated with underlying creative content (a film, television program, musical composition, or publication having multiple authors, as examples), an embodiment of the disclosure may be used for multiple types of content (or individual items), multiple business models or arrangements, or for components that are assembled into a product or service, as non-limiting examples.

As shown in FIG. 1, in one embodiment, the following steps, stages, processes, methods, operations, or functions may be implemented or performed:
Content creator/seller establishes account on marketplace platform (as suggested by step or stage 110);
   The content seller may be a single person, a single person representing others, or a single person representing an entity, as examples;
   The content may be an image, an audio track, a photograph, a composition, a recording, a manufactured item, an original work of art, a literary work, a motion picture, or a television program, as examples;
      In some embodiments, the content may instead be a collaboratively produced item, product, or service offering in which multiple people contribute a portion of a complete service, an assembly service step, a license to underlying intellectual property, or a packaging step, as examples;
The content creator/seller provides information regarding the content and terms of sale or licensing, such as one or more of (step or stage 120):
   An initial sale price;
   How payments or royalties are to be distributed to the collaborators or other participants in creating or marketing the content;
   The names/identifiers for each party or entity that is to receive a portion of the sale price, payments, and/or royalties;
   Relevant licensing conditions or terms that trigger an obligation to make a royalty payment or may otherwise generate revenue to be distributed;
      This may include mention of rights conveyed by the sale, rights withheld from the buyer, or rights available for purchase or licensing (local, regional, or worldwide distribution, derivative versions of content, recording of a live performance, reproduction in paperback format, use of a character or story element in a video game, use in a specific industry, or use in a specific class of products or services, as non-limiting examples);
The information provided by the content seller is processed by the platform to generate (step or stage 130):
   A token representing the underlying content (“minting” the NFT);
   One or more digital “wallets” with one wallet for each party or entity that is identified by the content creator/seller;
      Each wallet is in the form of data stored on a blockchain and may be protected by an identifier associated with each party or entity;
   A smart contract, rule-set, logic, or other form of a set of automatically triggered events, with each event defined by a rule, state, or condition as a predicate and a result or outcome (typically in the form of a decision or change in the state of a transaction, process, or relationship). The automatically triggered events may comprise one or more of:
      Payment for the sale of an NFT;
      Payment for the licensing of a right or rights to the underlying content of the NFT;
         Depending upon the type of content and/or business model of a relevant industry, this may include one or more of:
         a license to distribute the content in a market, geographical region, or location;
         a license to exhibit the content in a market, geographical location, or type of setting;
         to sub-license use of the content;
         to permit manufacture or use of a protected technique or device;
         to permit creation of a derivative work;
         to permit acquisition of franchising rights; or
         to permit reselling of a protected right, product, or service, as non-limiting examples;
      Enable distribution of a portion of payments or revenue received from the sale, distribution, exhibition, and/or licensing of a right to one or more of the identified persons, entities, or wallets;
         The distribution may be performed as defined by the information provided to the platform that identifies collaborators/recipients and their relative shares or percentages;
      A decrease or termination of royalty payments to one or more digital wallets after a period of time or amount paid;
   A record or records stored on the blockchain of the payments/royalties received, the parties or entities to which the payments/royalties have been distributed, and the rights to the underlying content that have been licensed (step or stage 140);
      Other information relevant to the content, the available or licensed rights, or the collaborators (as examples) may also or instead be stored on the blockchain;
Creation of a user interface or dashboard for each category of possible users—this may depend on a business model or industry, or the nature of a collaborative work, and may include NFT sellers, content financers, content distributors, content exhibitors, publishers, product assemblers, product manufacturers, or service providers for a specific industry, as non-limiting examples (step or stage 150);
   Each user interface or dashboard may include elements or tools to enable the user to:
      browse available content;
      select desired content;
      preview selected content;
      access pricing for selected content;
      submit a “bid” or offer for rights to the content or for a specific protected right;
      view the revenue generated by an item of content and how it has been distributed;
      view a graph showing the expected timeline for receipt of royalty payments for each wallet associated with the content;
      view royalty enabled indicators within the exploration of the content;
         in some embodiments, this refers to a situation where the creator of the NFT allows first-time NFT buyers to own a portion of a royalty with the creator, and doesn't exist on conventional marketplaces; or
      view a transaction history of the content.

Among other benefits, embodiments of the systems, apparatuses, and methods disclosed herein provide a secure and transparent solution to the problem of compensating collaborators on a joint project, where the project may be a task, a product, a service, an item of content, or a stage in the production of content or a product, as examples. Further, and depending upon the industry or business model that applies to the collaboration, there may be multiple events or activities involved in the use or consumption of content (or of a component) that result in the obligation of an entity to pay a fee, pay a royalty, or perform an action. In each of these instances, embodiments enable secure and reliable distribution of revenue to the appropriate entity and can do so in an automated and auditable way.

As an example, the entertainment industry conventionally relies on a complex and obscure system to distribute revenue from initial sales and revenue generated later from several forms of royalties. The system is complex enough and lacks sufficient transparency that content creators sometimes engage in legal disputes with major production companies to audit revenues generated from their work and determine what they are entitled to receive. The conventional payment system in the industry relies on trust and is ripe for misuse. One reason for this potential of misuse is that the payment system is centralized and can be manipulated. This makes it easier to disguise the amounts or sources of revenue and to shift revenue to categories that may not lead to payment to a content creator.

Industries vary and depending upon (1) the type of content or task involved (a product, a film, a work of art, a book, a device, a protected method or process, the distribution or exhibition of content, the manufacture or assembly of components, or the consumption of a product, as examples), (2) the types of rights available in the underlying content (to sell, to use, to manufacture, to distribute, to market, to exhibit, or to generate a derivative work, as examples), and (3) the entities or participants involved in utilizing content and/or exercising each available right, a different model or form of revenue distribution may be involved. Further, the revenue distribution may be “triggered” by different events or states of the overall payment system. This can make it particularly difficult to monitor and verify that the distribution of revenue is both fair and correct.

As is disclosed herein, the use of a specific combination of technical approaches and functionality enables the construction and management of a “marketplace” that operates to enable entities involved in a collaborative venture or business model to establish a trustworthy, reliable, and efficient payment system for the venture or business. In some embodiments, the disclosed payment system may comprise the following features or components:
the creation of a digital asset in the form of an NFT that represents the underlying content, component, or element being made available for sale, licensing, or other form of monetization;
the persons or entities involved in the creation, distribution, exhibition, manufacture, or assembly of the content, component, or element;
   an identification of the respective “share” of revenue generated by an event, content use, or state that each person or entity is to receive;
the conditions, events, or states that “trigger” an automated payment to an entity or person;
the creation of a secure and transparent record of the payments that are distributed and/or that the venture or model is obligated to distribute; and
the ability of an entity or person to access and monitor the record to verify their right to a payment and that the payment has been made to their respective account (such as their digital wallet).

As will be described, a combination of using a blockchain, an NFT, and a smart contract in the manner disclosed enables the construction of a payment system that overcomes the disadvantages of conventional approaches and is able to be used with multiple types of content and business models. The NFT and associated blockchain stored data represent (such as by defining or describing) the content involved (or the component or element), identify the collaborators and their respective share of any revenue, and define the conditions or situations under which one or more of the collaborators are to receive a payment. A sale or transfer of the NFT provides access to all the information in a secure and transparent way and automates the distribution of payments or revenue to the appropriate entity or person by transferring the funds they are entitled to into a digital “wallet”.

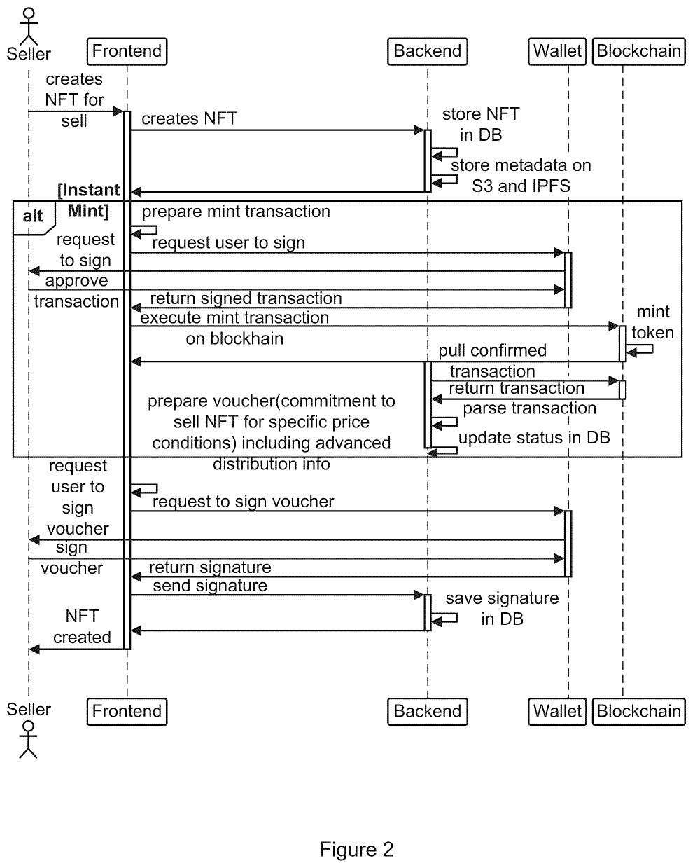

FIG. 2 is a flow diagram illustrating a process for creating an NFT representing underlying content that may be used in implementing an embodiment of the systems and methods disclosed herein. In one embodiment, the process may include the following set of stages, steps, functions, processes, or operations:
a. In one embodiment, the illustrated process starts with a Seller (which may be a content creator or representative for a creator or creators) initiating a process to create an NFT for sale, where the NFT will be displayed on one or more pages of the system (such as the Seller page and a page listing available NFTs);
b. The NFT information is stored in a database and storage server (for example, via IPFS and Amazon S3, where IPFS may be used for decentralization and Amazon S3 for caching purposes for the speed of a website). The NFT is now ready to be used in a “minting” process;
c. Prepare for the minting process via a selected minting sequence or set of operations (identified as Instant Mint in the figure);
d. The front end sends a signature request to the user's (Seller's) digital “wallet”;
e. The wallet sends the user a request to sign;
f. The user approves the transaction through a signed confirmation;
g. The approved signed transaction is sent back to the user's (Seller's) wallet;
h. The wallet returns the signed transaction to the front-end;
i. The front end executes the mint transaction on the blockchain;
j. The blockchain then mints the NFT (a token) and sends it back to the front-end and back-end;
k. The back-end pulls data related to a confirmed transaction and sends it back to the blockchain (i.e., after the blockchain mints the token, the backend pulls that information);
l. The blockchain returns the NFT minting transaction to the back-end, which then goes through the parsing process so humans can read the data;
m. The back-end database is updated;
n. After that, preparation for the voucher begins—the voucher is a commitment to sell the NFT tinder specific pricing and/or other conditions, and includes the distribution information for a sale or royalty split, a timetable for the payment of royalties when an NFT is sold or a right is licensed on a secondary market, and its price percentage that is configured in relation to the timetable; (i.e., the NFT creator can set a royalty timetable such as 5 years 10%, 4 years 8%, or 3 years 5%, as examples. This capability does not exist in conventional marketplaces, which tend to distribute royalties in perpetuity.);
o. After preparation of the voucher, a request to sign the voucher is sent to the blockchain;
p. The blockchain sends a request for the user (Seller) to sign the voucher;
q. The user (Seller) signs the voucher which sends it back to the blockchain;
r. The blockchain sends the signed voucher back to the front-end;
s. The front-end website sends the signed voucher ort a confirmation to the back-end of the website;
t. The back-end saves the signature in the back-end database; and
u. The NFT is created.

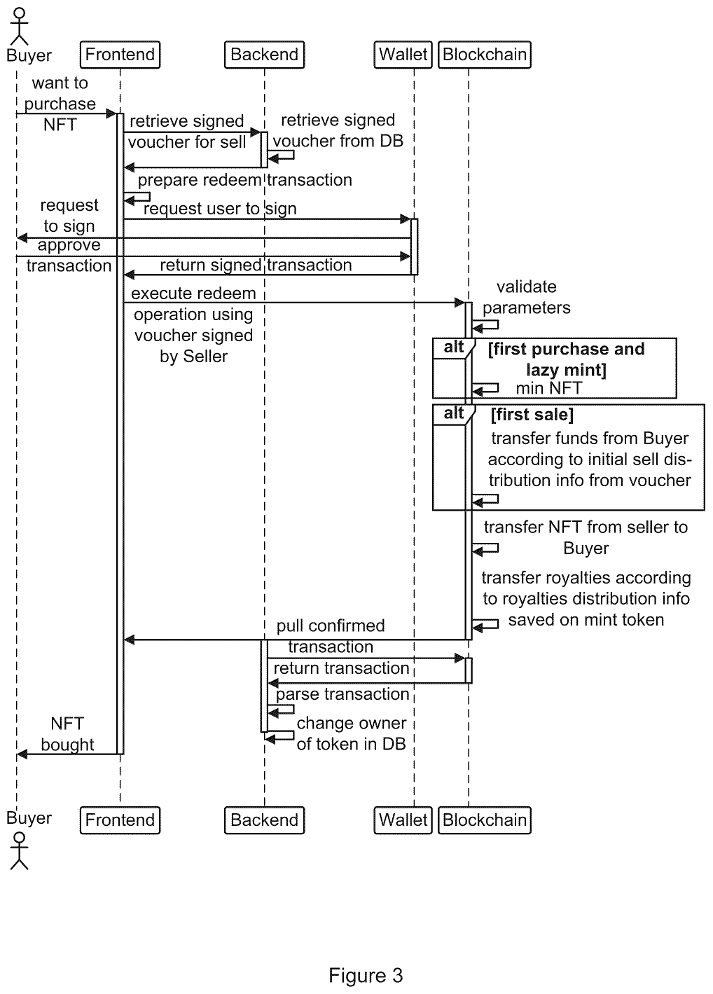

FIG. 3 is a flow diagram illustrating a process, method, function, or operation for using an NFT as part of a purchase, in accordance with one or more embodiments of the systems and methods disclosed herein. In one embodiment, the process may include the following set of stages, steps, functions, processes, or operations:
a. The process starts with a buyer initiating a process to purchase an NFT;
b. When the buyer initiates the purchasing process, the front-end requests the signed voucher for the Seller from the back-end;
c. The back-end retrieves the signed voucher from the Database;
d. The front-end prepares to redeem the transaction (i.e., it will prepare the request for the user to sign);
e. A request to sign the voucher is sent to the user's (Buyer's) digital wallet;
f. The wallet sends a request to sign the voucher to the user (Buyer);
g. The user (Buyer) signs the voucher and approves the transaction, a record of which is sent back to the wallet;
h. The wallet returns the signed transaction to the front-end;
i. The front-end executes a redeeming operation using the voucher signed by the Seller, and a record of the redeeming operation is sent to the blockchain;
j. The blockchain validates the transaction parameters via one of two options;
   1. Still on the blockchain, for a first-time purchase and lazy mint, the blockchain mints the NFT (note that typically there are 2 options for the NFT creator—they can mint the NFT and pay its “gas” fee or instead they can “lazy mint” it and have the buyer pay the gas fee.);
Note that tokens with certain types of associated revenue/financial distributions may not be able to be lazy minted, as that process may not allow financial conditions to be placed into a voucher on the blockchain. Instead, instant minting may be required and used.
   2. Still on the blockchain, for a first-time sale, transfer funds from Buyer according to initial sale revenue distribution described in voucher;
k. Transfer NFT from Seller to Buyer, and record on blockchain;
l. On blockchain, transfer appropriate royalties according to royalty distribution information saved on minted token (NFT);
m. Back-end pulls and confirms the transaction, and sends it to front-end, which also informs the NFT Buyer that the transaction has been confirmed;
n. The back-end returns the transaction;
o. The back-end parses the transaction; and
p. The back-end updates the Database to reflect the change of owner of the token (NFT).

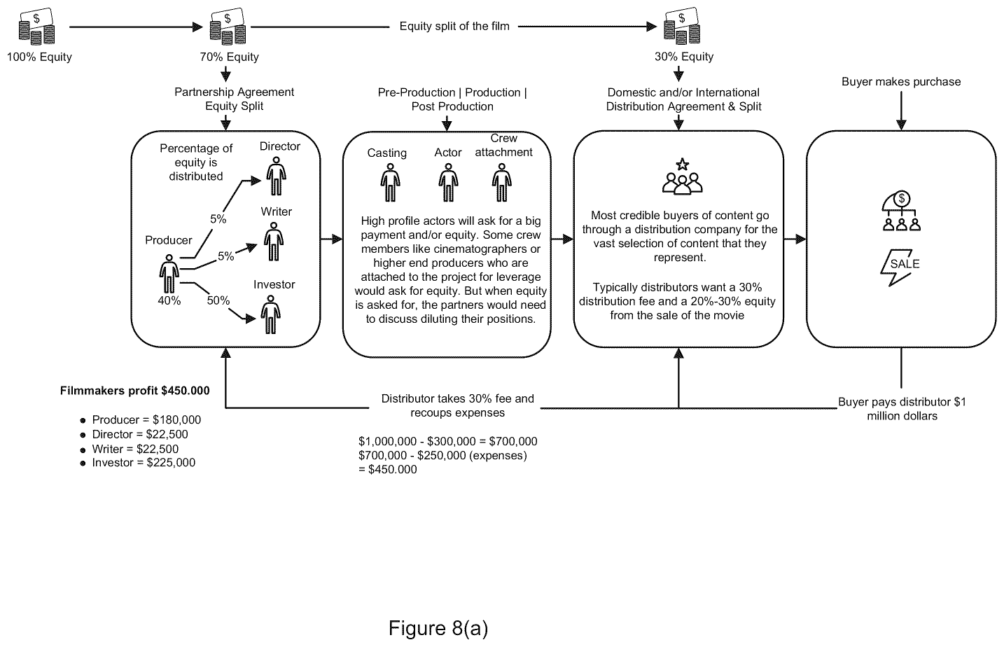

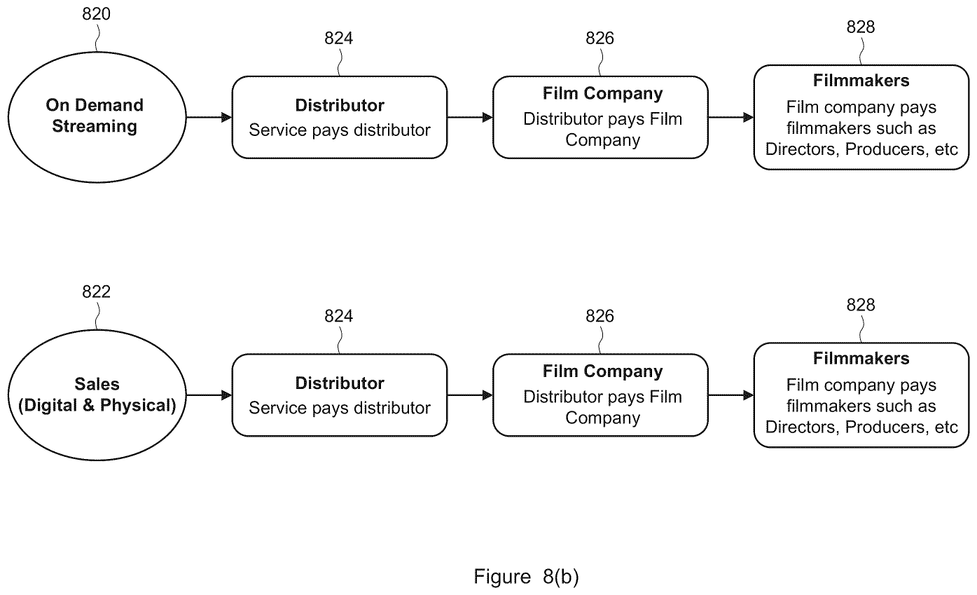

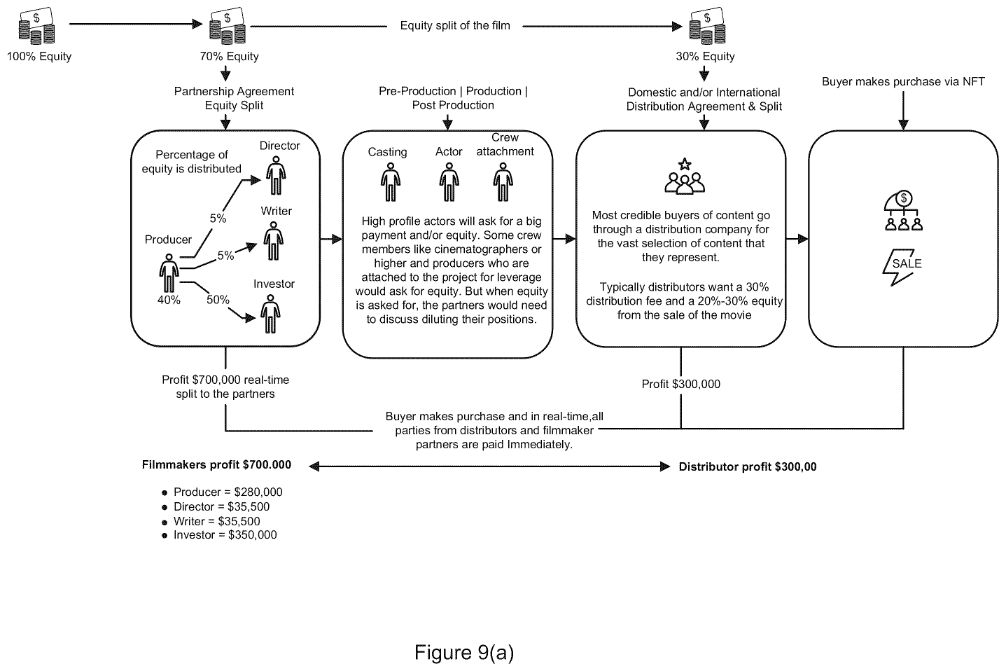

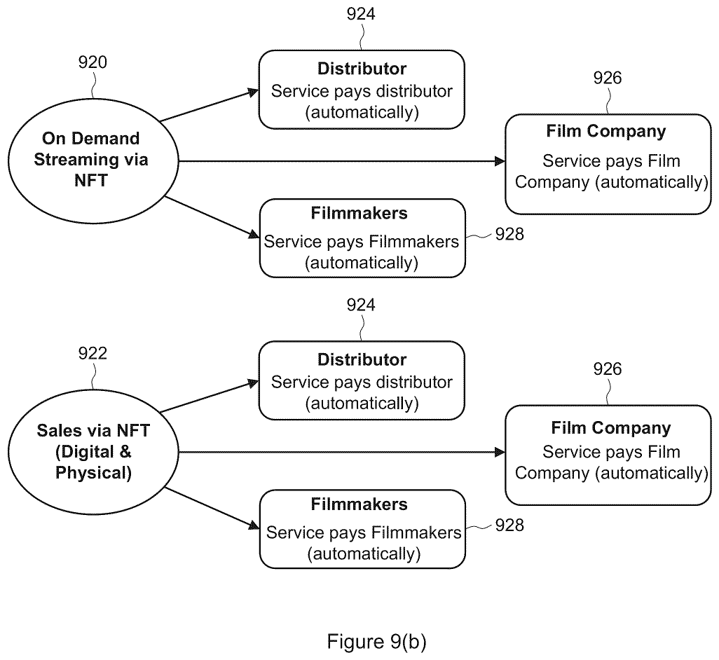

FIGS. 8(a) through 11 are diagrams illustrating the conventional business and revenue distribution model for the film industry (FIGS. 8(a) and 8(b)) and the business model and revenue distribution resulting from implementing an embodiment of the systems and methods disclosed herein (FIGS. 9(a) to 11).

FIG. 8(a) is a diagram illustrating a business model currently utilized in the film or similar industry to arrange for the sale and eventual distribution of content (such as a film or television program). As suggested by the figure, in a typical example, most film projects start with the originator of the plan to make a film having a 100% equity stake in the venture. They then look for or identify others with the skillset needed to make the project a reality. This typically involves entering into partnerships with one or more of writers, directors, actors, investors, and others involved in the overall process of creating the content.

In most cases, the parties with whom the project originator enters into a partnership desire an equity stake in the final product. As a result, the initial 100% equity position becomes distributed among multiple other parties. This means that when revenue is generated from a sale, distribution, or exhibition of the finished content (as examples for this business model), each equity owner may be entitled to some portion of that revenue. However, aspects of the revenue distribution and tracking are controlled by the project originator. For example, the payment period may depend on a distributor's payment terms and the tracking of payments is not transparent, as all of the possible recipients must trust the entities receiving the revenue for distribution and the records they maintain. In contrast, the tracking, monitoring, and transparent distribution of the revenue received from any source or due to any related event is provided by embodiments of the disclosed system and methods.

FIG. 8(b) is a diagram illustrating the flow of revenue in the business model of FIG. 8(a). As shown in the figure, in the example of either on-demand video streaming of content or the sale of a digital or physical copy of the content, revenue flows from the seller (the platform providing the streaming content 820 or the on-line or physical store providing the content 822) to a Distributor of the content 824 in an agreed upon amount or percentage. Distributor 824 then pays an agreed upon amount or percentage to the Film Company 826 which was responsible for creating and making the content available.

Film company 826 is then responsible for providing an appropriate share of the revenue to each of the multiple parties involved in the joint effort to create the content, identified as the Filmmakers 828 in the figure. Filmmakers 828 may include parties such as directors, producers, actors, or cinematographers, as examples, with the revenue provided in an agreed upon amount or percentage. In a typical example of a revenue split, from the initial 100% equity, the creators of the project (which may include a producer, director, writer, and investor) own 70%. Of the 70%, a producer my receive 40% (0.4×0.7 of the original equity), a director 5%, a writer 5%, and an investor 50% (of the 70%). The remaining 30% of the original equity is allocated to the distributor (where it is typical for a distributor to receive equity for selling the project).

FIG. 9(a) is a diagram illustrating a corresponding business model to that illustrated in FIG. 8(a), when implemented using an embodiment of the systems and methods disclosed herein. FIG. 9(b) is a diagram illustrating the flow of revenue in the business model of FIG. 9(a). As shown in the figures, in the example of either on-demand video streaming of content or the sale of a digital or physical copy of the content, revenue flows from the seller (the platform providing the streaming content 920 or the on-line or physical store providing the content 922) to more than a single recipient (as was the case in the model of FIGS. 8(a) and 8(b)).

As suggested by the figure, in a typical example, most film projects start with the originator of the plan to make a film having a 100% equity stake in the venture. They then look for or identify others with the skillset needed to make the project a reality. This typically involves entering into partnerships with one or more of writers, directors, actors, investors, and others involved in the overall process of creating the content.

In most cases, the parties with whom the project originator enters into a partnership desire an equity stake in the final product. As a result, the initial 100% equity position becomes distributed among multiple other parties. This means that when revenue is generated from a sale, distribution, or exhibition of the finished content (as examples for this business model), each equity owner may be entitled to some portion of that revenue. However, instead of aspects of the revenue distribution and tracking being controlled by the project originator, the tracking, monitoring, and transparent distribution of the revenue received from any source or due to any related event is provided by embodiments of the disclosed system and methods. This encourages participation and trust among participants. Further, embodiments provide a mechanism for auditing income from events related to the content and may be used by governmental or regulatory entities if needed to ensure compliance with regulations or statutes.

For example, as shown in FIG. 9(b), revenue may flow from a seller 920 or 922 to each of a distributor 924, a film company 926, and a filmmaker 928. This direct payment approach reduces the possibility of a dispute over what a party is entitled to, and because of the way the payment processing is implemented (as disclosed herein), a secure and transparent audit trail is also made available to the parties to an agreement. Further, payments may be made automatically (for example, by satisfaction of a condition expressed in a smart contract), with any revenue due being transferred directly to a user's digital wallet. This provides both an automatically executing and reliable form of payment, which is lacking in the conventional approach.

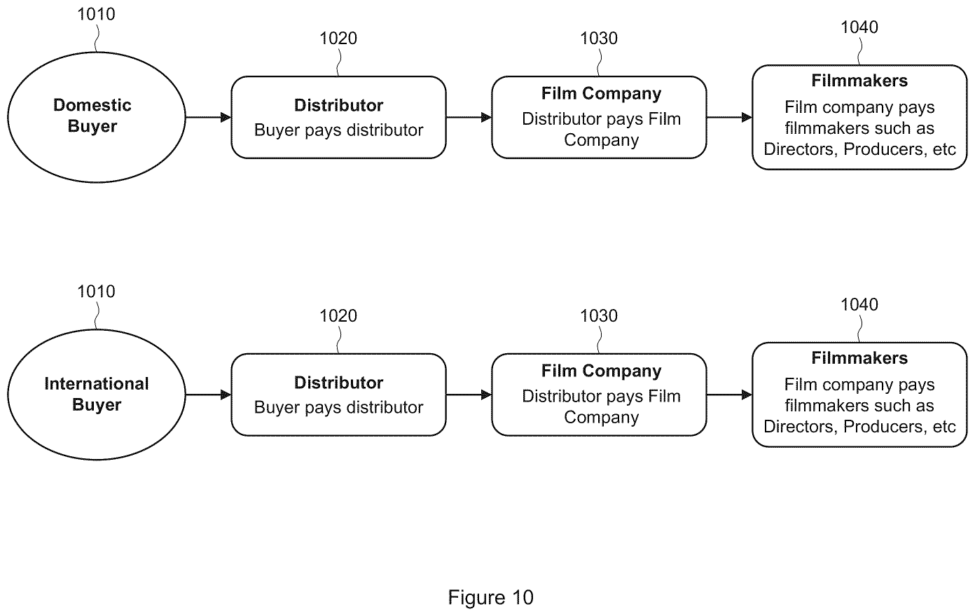

FIG. 10 is a diagram illustrating the flow of revenue for an acquisition and that is currently utilized in the film or similar industry. In this revenue model, a buyer of the underlying content 1010 (which may be a domestic or international buyer) provides funds to a distributor 1020, who then provides a portion of those funds to a film company 1030, who then provides a portion of what they receive to the filmmakers 1040. As shown in the figure, the flow of the payment is from one party to the next instead of directly to each party. This revenue flow is both susceptible to greater delay and misuse than an embodiment of the disclosed direct payment model.

Note that in comparison to FIGS. 8A and 8B, the buyer in FIG. 10 is a different type of entity. In FIGS. 8A and 8B, the business model involves on demand streaming, the sale of a physical product, or a digital download of content which involves different payment methods and process flows. In contrast, in FIG. 10, the purchase is of the content and more of its rights, such as a corporation purchasing the content to own it and distribute it in accordance with their own business model.

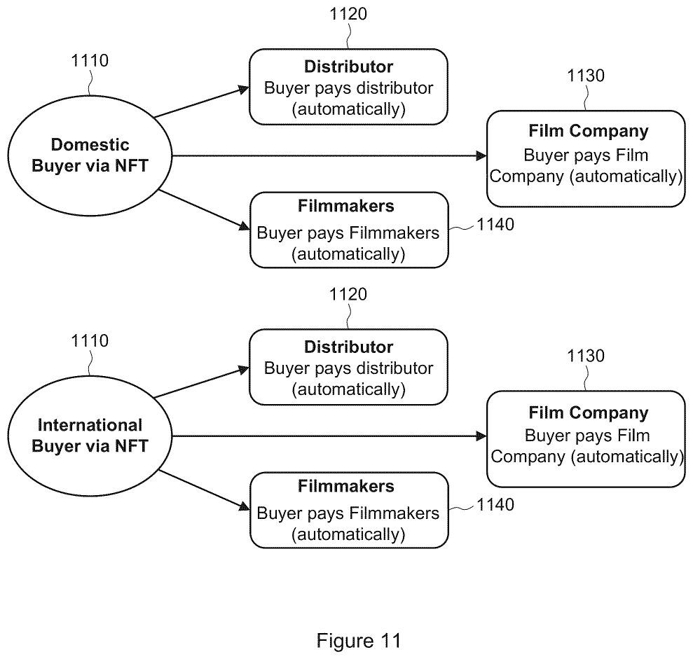

FIG. 11 is a diagram illustrating the flow of revenue for an acquisition when implemented using an embodiment of the systems and methods disclosed herein. As shown in the figure, in an embodiment of the disclosed system and methods, the payment by a domestic or international buyer 1110 is provided directly (in an appropriate amount) to multiple parties, including, as examples, a distributor 1120, a film company 1130, and a filmmaker 1140. In each case, the appropriate payment is made directly, automatically, and in a manner that creates a secure record for purposes of an audit trail.

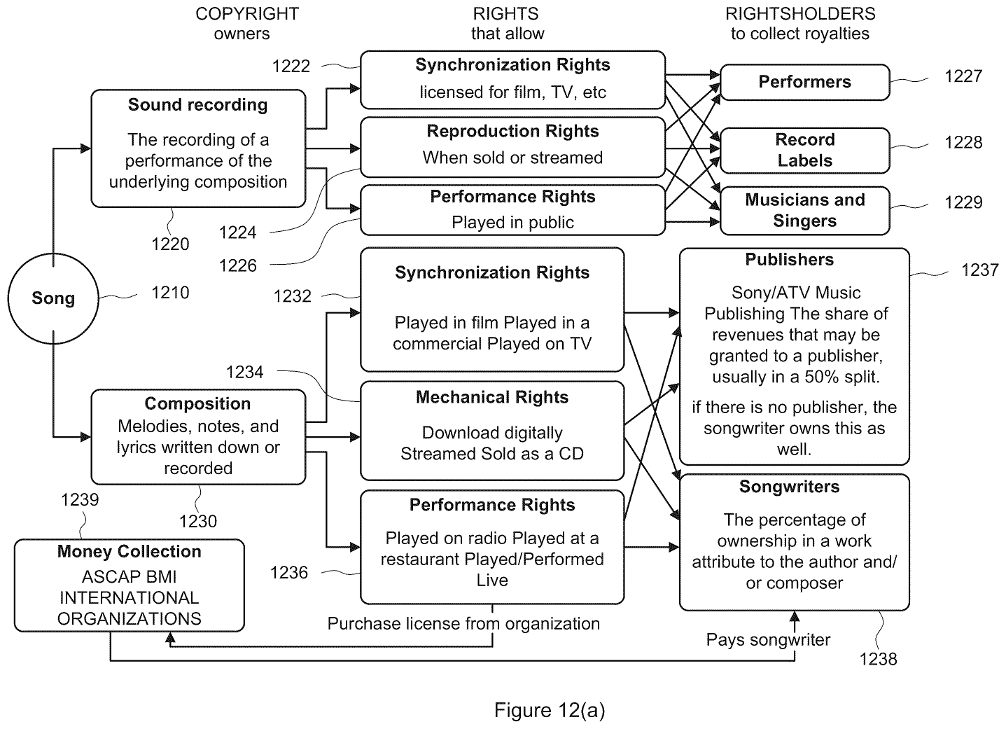

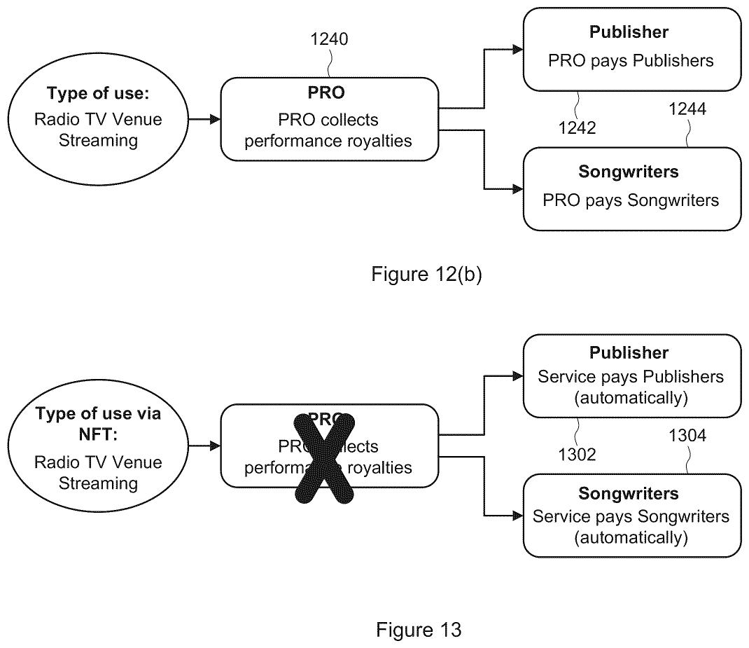

FIG. 12(a) is a diagram illustrating a business model currently utilized in the music or similar industry for the sale of content. FIG. 12(b) is a diagram illustrating the flow of revenue in the business model of FIG. 12(a) for a public performance of a composition. The music industry is one that illustrates a situation in which an item of content may be consumed or used in multiple ways, with each way of consumption or use associated with a separate and licensable right. For example, with a composition, the composition may be published, performed live, recorded, and/or played from a recording. Each use case has its own associated rights that may be a source of revenue that needs to be properly distributed to the parties involved (who may include composers, publishers, performers, sound engineers, recording studios, record labels, or musicians and singers on a recording, as examples).

Referring to FIG. 12(a), a song 1210 is the creation of a composer/songwriter and may be associated with a set of recording related rights 1220 and a set of composition related rights 1230. The sound recording rights 1220 may include rights for use in a film or program (termed synchronization rights 1222 in the figure), rights to sell or stream the recorded composition (termed reproduction rights 1224 in the figure), and rights to perform the composition in public (termed performance rights 1226 in the figure). Payments made to an entity for either synchronization, reproduction, or performance rights then need to be properly distributed to performers 1227, record labels 1228, and musicians and singers 1229.

Composition rights 1230 may include rights for use in a film or program (termed synchronization rights 1232 in the figure), rights to sell or stream the recorded composition (termed mechanical rights 1234 in the figure), and rights to have a recording of the composition played or in some cases performed in public (termed performance rights 1236 in the figure). Payments made to an entity for either synchronization, mechanical, or performance rights then need to be properly distributed to Publishers 1237 and songwriters 1238. Because of the complexity of tracking the uses and performance of compositions, particularly the playing of a recorded composition on the radio or in a venue, organizations have been created to license the rights and collect payment for the licenses, and then distribute the payments to songwriters 1238 (as suggested by ASCAP 1239 in the figure).

As a non-liming example, mechanical rights royalties may take the form of the following payments:
TV—$30,000 to $60,000 for a popular song;
Ad Campaign—$25,000 to $400,000;
Videogame—$5000 to $20,000; and
Movie—$50,000 to $100,00 or more.
   The terms or amounts are typically negotiable and paid upfront by the entity desiring the license or rights.

As an example of an implementation, in a usage of an embodiment of the disclosure, a hardware device compatible with NFT use and licensing may be used. In this example, each time a song is played, it is shown as having been played on the blockchain, thus creating transparency, and enabling efficient distribution of any royalties to which a creator is entitled. It is expected that this process will increase trust, partnerships, and creative collaborations, as payments would be directly sent to the copyright owners.

As suggested by FIG. 12(a), the music industry currently utilizes a payment system in which there are both multiple interested parties and multiple rights that may be the basis for generating a payment. This results in a complex and opaque flow of payments that is subject to dispute and delay, while lacking a reliable audit trail or a mechanism for efficient automation.

As shown in FIG. 12(b), for the type of uses shown (Radio, TV, Venue, Streaming of a recording of a composition), the Producer 1240 (indicated by “PRO” in the figure) collects or receives the performance royalties and then distributes them in the appropriate shares to the Publisher 1242 and Songwriters 1244. As with the other conventional approaches to royalty distribution described, this involves an intermediary (the Producer 1240) who is relied upon and trusted to obtain and efficiently redistribute the royalty payments. For one of several reasons, this may not occur or may not occur in an efficient and time-sensitive manner.

FIG. 13 is a diagram illustrating the flow of revenue for a public performance of a composition when implemented using an embodiment of the systems and methods disclosed herein. As suggested by the figure, in some embodiments, the role of the Producer in distributing royalty payments is eliminated and instead the disclosed service platform (not shown) is responsible for transferring earned royalty payments directly and automatically to the appropriate Publisher 1302 and Songwriters 1304. This arrangement reduces the delay in payment of earned royalties to the appropriate recipient, is performed in a transparent way that is less subject to fraud and provides an audit trail that may be used to ensure all payments have been made and are properly recorded. As suggested by the figure, in an embodiment of the disclosed system or platform, the content is purchased for use by an entity purchasing or licensing a NFT that is associated with and represents the underlying content.

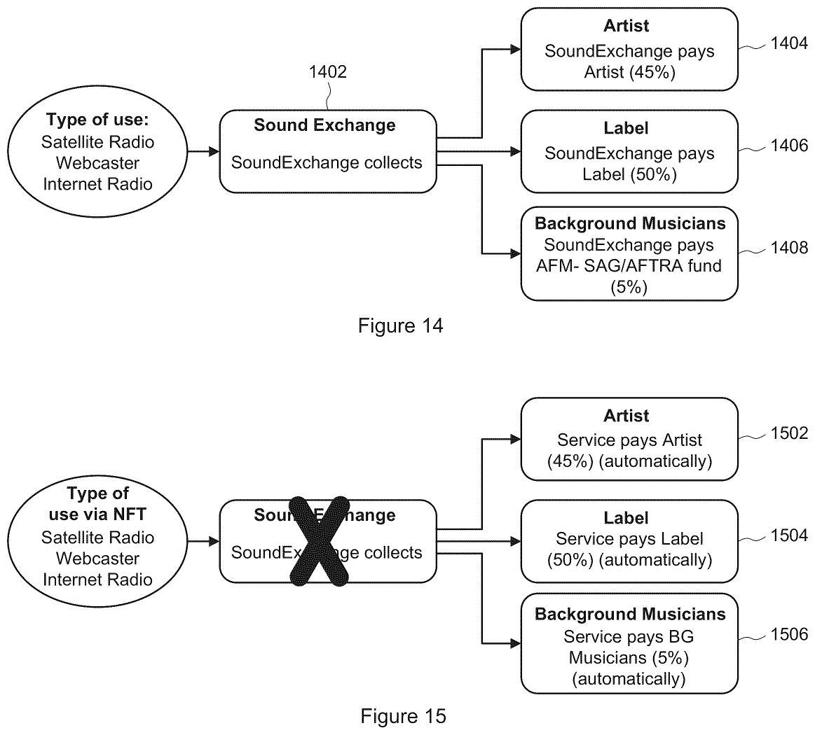

FIG. 14 is a diagram illustrating the flow of revenue in the business model of FIG. 12(a) for a public performance of a composition that includes a recording of the performance. As shown in the figure, for the type of uses shown (Satellite Rdio, Webcaster, or Internet Radio, as examples), an organization such as Sound Exchange 1402 (a digital rights management organization²) collects or receives the performance royalties and then distributes them in the appropriate shares to the Artist (the performer) 1404, the Label 1406, and the Background Musicians 1408. As with the other conventional approaches to royalty distribution described, this involves an intermediary (Sound Exchange 1402) who is relied upon and trusted to obtain and efficiently redistribute the royalty payments. For one of several reasons, this may not occur or may not occur in an efficient and time-sensitive manner. ² https://www.soundexchange.com/.

FIG. 15 is a diagram illustrating the flow of revenue for a public performance of a composition that includes a recording of the performance when implemented using an embodiment of the systems and methods disclosed herein. As suggested by the figure, in some embodiments, the role of the Sound Exchange (or similar organization) in distributing royalty payments is eliminated and instead the disclosed service platform (not shown) is responsible for transferring earned royalty payments directly and automatically to the appropriate Artists 1502, Label 1504, and Background Musicians 1506. This arrangement reduces the delay in payment of earned royalties to the appropriate recipient, is performed in a transparent way that is less subject to fraud and provides an audit trail that may be used to ensure all payments have been made and are properly recorded. As suggested by the figure, in an embodiment of the disclosed system or platform, the content is purchased for use by an entity purchasing or licensing a NFT that is associated with and represents the underlying content.

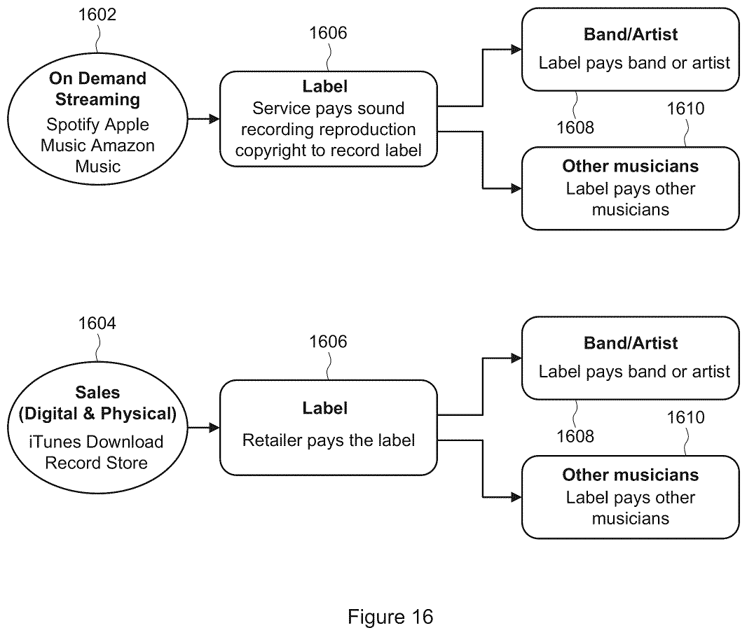

FIG. 16 is a diagram illustrating the flow of revenue in the business model of FIG. 12(a) for a reproduction of a recording of a performance, such as via on-demand streaming or the sale of a physical or digital copy of a recording. As shown in the figure, the source of the distribution of the reproduction (as suggested by On Demand Streaming 1602 or Sales (Digital & Physical) 1604), provides payment to the Label 1606, where the payment is provided by a streaming service or a retailer. Label 1606 then provides payment of the appropriate amount of a royalty to the Band or Artist 1608 and Other musicians (if applicable) 1610. As with other forms of conventional approaches to royalty distribution described, this involves an intermediary (Label 1606) who is relied upon and trusted to obtain and efficiently redistribute the royalty payments. For one of several reasons, this may not occur or may not occur in an efficient and time-sensitive manner.

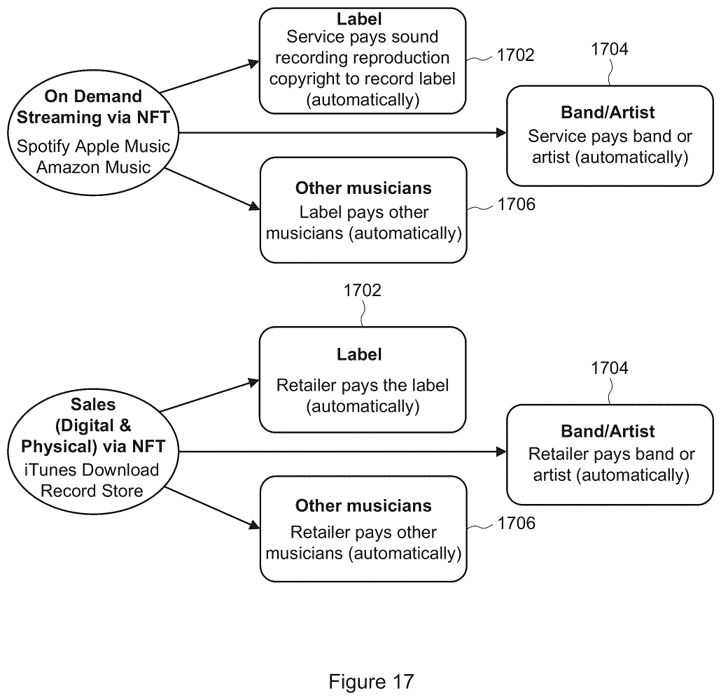

FIG. 17 is a diagram illustrating the flow of revenue for a reproduction of a recording of a performance when implemented using an embodiment of the systems and methods disclosed herein. As suggested by the figure, in some embodiments, the role of the Label (or similar organization) in distributing royalty payments is eliminated and instead the disclosed service platform (not shown) is responsible for transferring earned royalty payments directly and automatically to the Label 1702, the Band or Artist 1704, and the Other Musicians 1706. This arrangement reduces the delay in payment of earned royalties to the appropriate recipient, is performed in a transparent way that is less subject to fraud and provides an audit trail that may be used to ensure all payments have been made and are properly recorded. As suggested by the figure, in an embodiment of the disclosed system or platform, the content is purchased for use by an entity purchasing or licensing a NFT that is associated with and represents the underlying content.

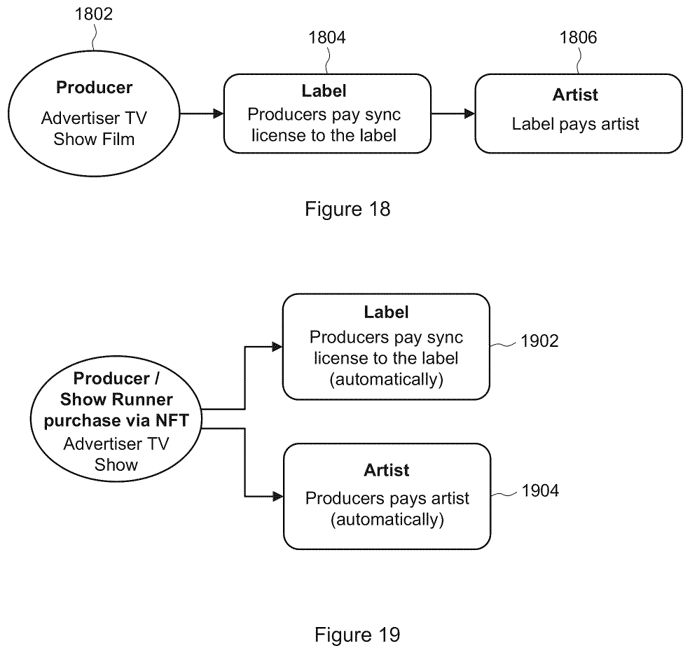

FIG. 18 is a diagram illustrating the flow of revenue in the business model of FIG. 12(a) for a sync or master use. In this context, a “sync” means the music that would be synchronized with visual images as part of a motion picture or other audio-visual content. A motion picture company, film company, or studio will typically buy a “sync” license to be able to construct a film with a desired music soundtrack.

As shown in the figure, in the conventional approach, a Producer 1802 (for example an advertiser, a producer of a television program, or a producer of a film) pays a Label 1804 a royalty termed a synch license payment, with the Label 1804 then distributing the appropriate amount to the Artist 1806. As with the other conventional approaches to royalty distribution described, this involves an intermediary (Label 1804) who is relied upon and trusted to obtain and efficiently redistribute the royalty payments. For one of several reasons, this may not occur or may not occur in an efficient and time-sensitive manner.

FIG. 19 is a diagram illustrating the flow of revenue for a sync or master use when implemented using an embodiment of the systems and methods disclosed herein. As suggested by the figure, in some embodiments, the role of the Label (or similar organization) in distributing royalty payments is eliminated and instead the disclosed service platform (not shown) is responsible for transferring earned royalty payments directly and automatically to the Label 1902 and Artist 1904. This arrangement reduces the delay in payment of earned royalties to the appropriate recipient, is performed in a transparent way that is less subject to fraud and provides an audit trail that may be used to ensure all payments have been made and are properly recorded. As suggested by the figure, in an embodiment of the disclosed system or platform, the content is purchased for use by an entity purchasing or licensing a NFT that is associated with and represents the underlying content.

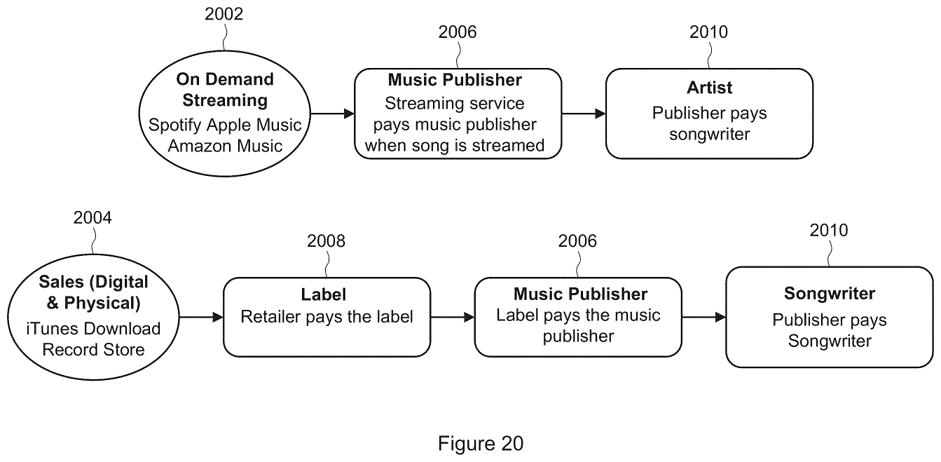

FIG. 20 is a diagram illustrating the flow of revenue in the business model of FIG. 12(a) for the composer of a composition in a situation where their composition is the subject of a recording distributed via on-demand streaming or the sale of a physical or digital copy of a recording. As shown in the figure, the source of the distribution of the reproduction (as suggested by On Demand Streaming 2002 or Sales (Digital & Physical) 2004), provides payment to an intermediary (as suggested by Music Publisher 2006 or Label 2008). In the situation of On Demand Streaming, the Streaming Service 2002 provides payment to the Music Publisher 2006, who then provides the appropriate payment to the Artist (in this case the Songwriter or Composer) 2010. In the situation of a Sale (Digital & Physical), the Retailer provides payment to the Label 2008, who then provides the appropriate payment to the Music Publisher 2006, who then provides payment to the Artist (in this case the Songwriter or Composer) 2010. As with the other conventional approaches to royalty distribution described, this involves an intermediary (Music Publisher 2006 and/or Label 2008) who is relied upon and trusted to obtain and efficiently redistribute the royalty payments. For one of several reasons, this may not occur or may not occur in an efficient and time-sensitive manner.

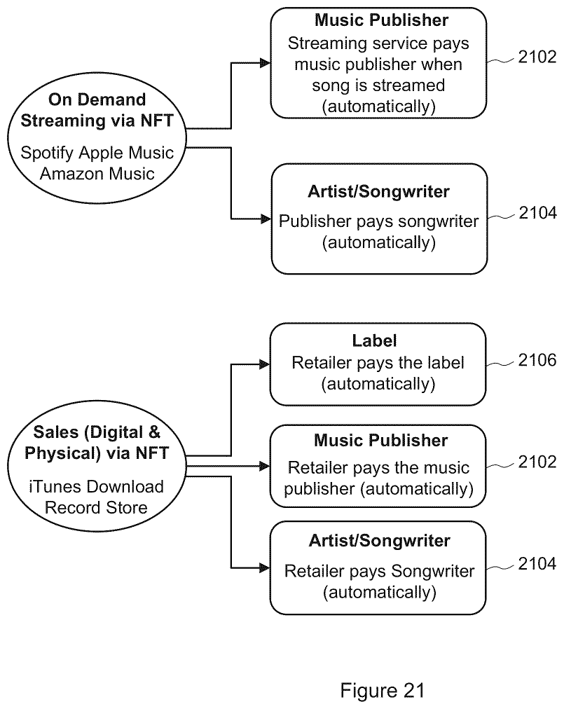

FIG. 21 is a diagram illustrating the flow of revenue for the composer of a composition (such as a Songwriter) when implemented using an embodiment of the systems and methods disclosed herein. As described with reference to FIG. 20, this illustrates a situation where a composition is the subject of a recording distributed via on-demand streaming or the sale of a physical or digital copy of a recording. As suggested by the figure, in some embodiments, the role of the intermediary (the Label or Music Publisher in FIG. 20) in distributing royalty payments is eliminated and instead the disclosed service platform (not shown) is responsible for transferring earned royalty payments directly and automatically to the Music Publisher 2102, the Artist/Songwriter 2104, or the Label 2106 as illustrated in FIG. 21. This arrangement reduces the delay in payment of earned royalties to the appropriate recipient, is performed in a transparent way that is less subject to fraud and provides an audit trail that may be used to ensure all payments have been made and are properly recorded. As suggested by the figure, in an embodiment of the disclosed system or platform, the content is purchased for use by an entity purchasing or licensing a NFT that is associated with and represents the underlying content.

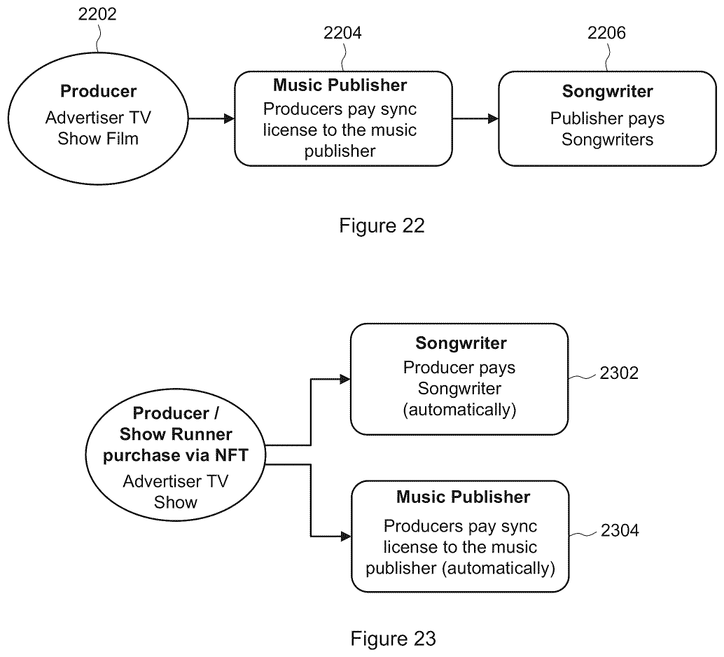

FIG. 22 is a diagram illustrating the flow of revenue in the business model of FIG. 12(a) for a sync or master use to the composer or songwriter. As shown in the figure, in a conventional royalty distribution model, a Producer 2202 is responsible for making a royalty payment to a Music Publisher 2204, and the Music Publisher 2204 is responsible for distributing the appropriate royalty payment to the Songwriter(s) 2206. As with the other conventional approaches to royalty distribution described, this involves an intermediary (Music Publisher 2204) who is relied upon and trusted to obtain and efficiently redistribute the royalty payments. For one of several reasons, this may not occur or may not occur in an efficient and time-sensitive manner.

FIG. 23 is a diagram illustrating the flow of revenue for a sync or master use to the composer or songwriter when implemented using an embodiment of the systems and methods disclosed herein. As suggested by the figure, in some embodiments, the role of the Music Publisher (or similar organization) in distributing royalty payments is eliminated and instead the disclosed service platform (not shown) is responsible for transferring earned royalty payments directly and automatically to the Songwriter(s) 2302 and Music Publisher 2304. This arrangement reduces the delay in payment of earned royalties to the appropriate recipient, is performed in a transparent way that is less subject to fraud and provides an audit trail that may be used to ensure all payments have been made and are properly recorded. As suggested by the figure, in an embodiment of the disclosed system or platform, the content is purchased for use by an entity purchasing or licensing a NFT that is associated with and represents the underlying content.

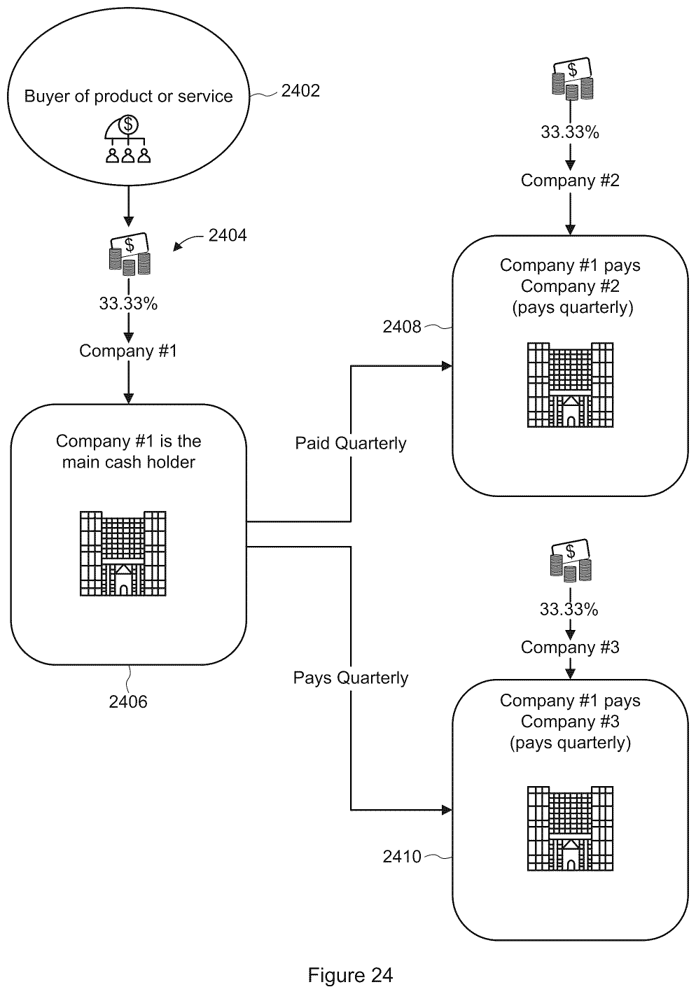

FIG. 24 is a diagram illustrating the flow of revenue for a partnership business model using a conventional revenue distribution approach. As shown in the figure, in a conventional arrangement, a purchaser of a product or service 2402 makes a direct payment or initiates a transfer of funds 2404 to a company (identified as Company #1 2406 in the figure). Company #1 2406 acts as an intermediary and is responsible for distributing all or a portion of the received funds 2404 to one or more other companies (identified as Company #2 2408 and Company #3 2410 in the figure). As suggested by the figure, the payments or transfers to Company #2 2408 and Company #3 2410 may be scheduled to occur quarterly or on another time scale. As with the other conventional approaches to royalty distribution described, this involves an intermediary (Company #1 2406) who is relied upon and trusted to obtain and efficiently redistribute the royalty payments. For one of several reasons, this may not occur or may not occur in an efficient and time-sensitive manner.

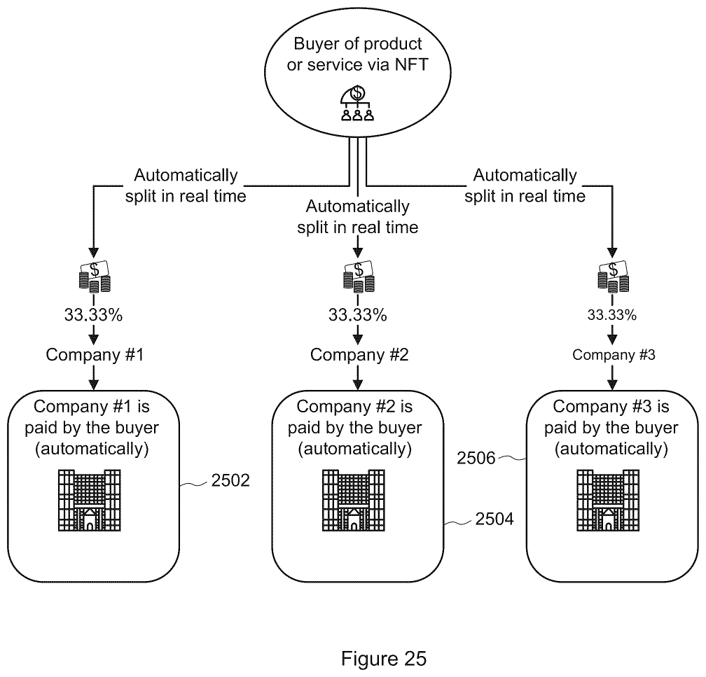

FIG. 25 is a diagram illustrating the flow of revenue for a partnership business model when implemented using an embodiment of the systems and methods disclosed herein. As suggested by the figure, in some embodiments, the role of the intermediary Company #1 in distributing royalty payments is eliminated and instead the disclosed service platform (not shown) is responsible for transferring earned royalty payments directly and automatically to the participants in the joint venture, that is Company #1 (2502), Company #2 (2504), and Company #3 (2506). This arrangement reduces the delay in payment of earned royalties to the appropriate recipient, is performed in a transparent way that is less subject to fraud and provides an audit trail that may be used to ensure all payments have been made and are properly recorded. As suggested by the figure, in an embodiment of the disclosed system or platform, the content is purchased for use by an entity purchasing or licensing a NFT that is associated with and represents the underlying product or service.

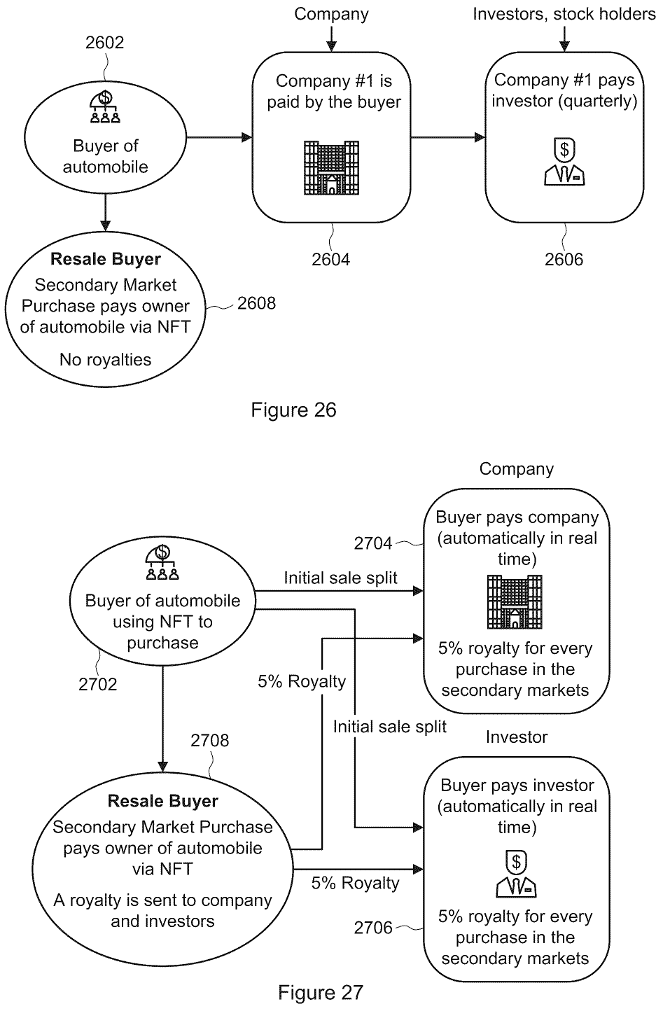

FIG. 26 is diagram illustrating the flow of revenue for a purchase of a product (in the example, an automobile) using a conventional revenue distribution approach. As shown in the figure, in a conventional approach, a buyer of a product 2602 provides payment to a Company 2604 which may represent a manufacturer or distributor of the product. Company 2604 operates a business which may provide a return to investors or stockholders 2606 on a scheduled basis. Buyer 2602 may later decide to sell the product to another entity, referred to as a Resale Buyer 2608 in the figure. As suggested by the figure, this secondary transaction with resale Buyer 2608 does not generate any royalty or payment to Company 2604. As with the other conventional approaches to royalty distribution described, this involves an intermediary (Company 2604) who is relied upon and trusted to obtain and efficiently redistribute the royalty payments. For one of several reasons, this may not occur or may not occur in an efficient and time-sensitive manner.

FIG. 27 is a diagram illustrating the flow of revenue for a purchase of a product (in the example, an automobile) when implemented using an embodiment of the systems and methods disclosed herein. As suggested by the figure, in some embodiments, the role of the intermediary Company in distributing royalty payments is eliminated and instead the disclosed service platform (not shown) is responsible for transferring earned royalty payments directly and automatically to the other parties. In this example, a buyer 2702 makes a payment which is then automatically distributed to Company 2704 and to investors or stockholders 2706 (as suggested by the payment labeled “Initial sale split” in the figure). Further, upon a resale of the product by buyer 2702, the amount paid by Resale Buyer 2708 is automatically used to generate a royalty payment to Company 2704 and Investors 2706 (as suggested by the payment labeled “5% Royalty” in the figure). This arrangement reduces the delay in payment of earned royalties to the appropriate recipient, is performed in a transparent way that is less subject to fraud and provides an audit trail that may be used to ensure all payments have been made and are properly recorded. As suggested by the figure, in an embodiment of the disclosed system or platform, the product is purchased for use by an entity purchasing or licensing a NFT that is associated with and represents the underlying product or service. Further, the disclosed arrangement enables a royalty payment based on a sale in the secondary market, an advantage not possible with conventional approaches.

An example of a use case for an embodiment of the disclosure would be retail purchases for food, apparel, or services, where an NFT is used as a coupon type of utility. Industries can adopt NFTs as a coupon utility and use the sales and royalty split features as incentives to transparently manage and deliver value to their customers.

One use would be to allocate a certain percentage of a transaction or a payment as a contribution to a non-profit organization or charity, as is sometimes offered in a supermarket at check out. There are presently disincentives to donating in this way, as people appear reluctant to donate due to the lack of transparency. With an embodiment of the disclosure, the donations can be audited and verified on the blockchain. This means that a donator can verify where their funds went and can feel confident that no third party is managing the donations. In addition, on the secondary market, the royalties can continue to be donated to the charity.

Another usage of an embodiment would be using the NFT as a rewards card that includes royalties, an arrangement that traditional rewards cards cannot do effectively. In this example, the NFT creator can mint and “air drop” the NFT to anyone that has the public address (air drop refers to sending/transferring the NFT into another person's wallet without needing confirmation). The NFT can earn points and build value and the NFT owner can then sell it to the secondary market. However, because the NFT creator had customized the royalty to split to another wallet such as a charity organization, the charity will benefit from the rewards without ever having to audit or manage the NFT or transactions. As with the other example use cases, there is transparency since transactions are on the blockchain and all royalties would be able to be audited if needed for regulation purposes.

With regards to the licensing aspects that may be included as part of one or more embodiments of the disclosure, the following conditions or operational features may apply:
Conventionally, a license is a document that describes a payment structure and usage of content in legally binding terms;
In contrast, embodiments embed the license into an NFT using a legally binding “smart” contract, and automate the financial arrangements associated with the license within the NFT. This changes how the flow of revenue or royalties operates, and how the terms are executed;
   In some embodiments, the license and associated financial distribution terms are enforced through a legally binding requirement that the NFT must be bought to “activate” the license. To provide proof of purchase and the “right” to enforce and use the contract, the “title” of the NFT, contract address, and token ID may be included in the contract. As a result, with a single action, it can be confirmed on the blockchain—this represents a form of certifying the contract on the blockchain;
   Once the license is activated by the purchase of the NFT, it allows the content to be “unlocked” and accessed through a secondary page or location (accessible through the disclosed platform) which typically contains the terms or contents of the contract, the content characteristics for a specific license (such as a wav file, original jpg, or mov file, as examples), or other information relevant to the licensing and use of the content;
   Note that the described process protects the creators and partners in a collaboration, as they are paid upon the transaction being executed—this enables a frictionless payment experience that is legally binding, auditable, and transparent. As an example, if an artist's song is used in a manner not specified in the contract, then that misuse will be apparent because of the visibility of the contract terms.

Another form of licensing arrangement may involve content in the form of “stock” music, images, or video clips. Conventional approaches to licensing this form of content use a centralized business model that is not transparent or easily auditable. In contrast, embodiments provide a solution to this disadvantage of the conventional approaches:
When a license is activated, the buyer of the NFT is taken to a portal to download the “purchased” content;
   In one example embodiment, the content is in the form of an NET that enables the buyer to use the content subject to the license terms, which may limit use of the content to a specific number of uses, a type of use, the placement of the purchased content, or other form of restriction. This form of licensing enables the platform to send payments due to the content creator(s) directly from a buyer (such as an advertiser or other end-user of the content) to a seller (typically the content creators or their representative) upon executing a transaction (and as disclosed, the platform provides a mechanism for all parties involved in creating content to be paid in accordance with the defined royalty splits);
   The buyer of the NFT has transparency with regards to the legal terms covering the content and its use. This enables a music license (as an example) to be customized for a specific NFT and hence item of content. Such customization and the resulting transparency are difficult to achieve using a centralized and typically uniform approach, as in conventional licensing arrangements. For example, conventional, centralized licensing systems typically utilize a fixed set of terms and conditions to enable management of a system at scale and use a universal agreement with artists that are “onboarded” to their platform;
   In contrast, embodiments enable content creators to control and benefit from the licensing of their stock content and its various possible uses through use of a transparent and customizable set of licensing terms.

Another use case in which an embodiment provides benefits and improvements over conventional approaches is that of managing a temporary property rental or license for use, the associated split of sales, rentals fees, royalties, or other forms of revenue, and the timetable for payments. An example would be the concept of a timeshare to a property as represented and managed by use of an NFT format. A problem that may be encountered with a timeshare is being able to resell the timeshare to someone else when a present owner is no longer interested in owing it. Further, an owner of a timeshare is typically required to pay homeowners or other maintenance fees whether or not they use or lease a property. Embodiments may be used to assist in solving both problems.

Using an embodiment of the disclosure and an associated NFT for the rental or licensing of properties addresses many issues involving ownership and use of timeshares. These include enabling multiple investors in a property to be paid upon every NFT transaction, where the NFT is used to provide access to the rental property. Further, the NFT and associated contract can provide for payment to other services or products as part of the licensing or use terms.

Yet another use case involves the wedding industry. One of the challenges facing couples planning a wedding is having the time to shop, research, and identify all the vendors needed to create their wedding experience. This may include a DJ, photographer, videographer, hair/makeup artist, venue manager, dressmaker, or a wedding coordinator, as examples. In this situation, an embodiment solves the problem of a couple having to spend months researching to find the right vendors by instead enabling them to purchase an NFT that has all the vendors “packaged” or grouped into a single purchase. The split royalty format of the disclosed system/platform allows the vendors to not have to worry about a centralized workflow and the proper distribution of payments. Upon the purchase of the NFT, all vendors are paid their respective deposit to lock in the wedding date and their service, and then a second NFT purchase may be used to finalize the committed services. Within the NFT, each vendor may have their own contract terms defined and enabled through “purchase” of the NFT as a set of services.

Yet another benefit of an embodiment when used in this way is concerns the cancellation of an event. Consider a case where a wedding is booked months in advance, only for the couple to post-pone or cancel their wedding plans. In this situation, most vendors will not return a deposit. However, in this situation, the couple can put the NFT on the market and sell their NFT to a buyer, thereby benefitting the buyer, seller, and the vendors.

Referrals are also a problem in the wedding and other industries. A vendor referring a couple to another vendor is difficult to track and properly compensate. There is a lack of transparency in the referral process because there is not a standard software application that the industry uses. Embodiments allow vendors to make deals with each other and provide packaged offerings for couples to help them make a decision about their wedding plans. An example would be an NFT “package of services” such as DJ, venue, and photography services. Another NFT package could be Videography, DJ, Hair stylist, and a Photobooth. There can be many different combinations of such packages, and if an NFT package is bought by a couple, then the services are honored as with a conventional monetary transaction.

Note that the ability of an embodiment to provide a payment based on a sale or transfer of a product in a secondary market provides a mechanism for ensuring artists or creators receive recognition of their “moral” or other rights in a work. Embodiments provide a record of all sales or transfers of a work and can automatically generate a payment to the artist as the value of their work increases and it is exchanged. A similar model may be used for collectibles to provide payment to sculptors, artists, writers, or illustrators (as examples) as the value of their creation increases over time.

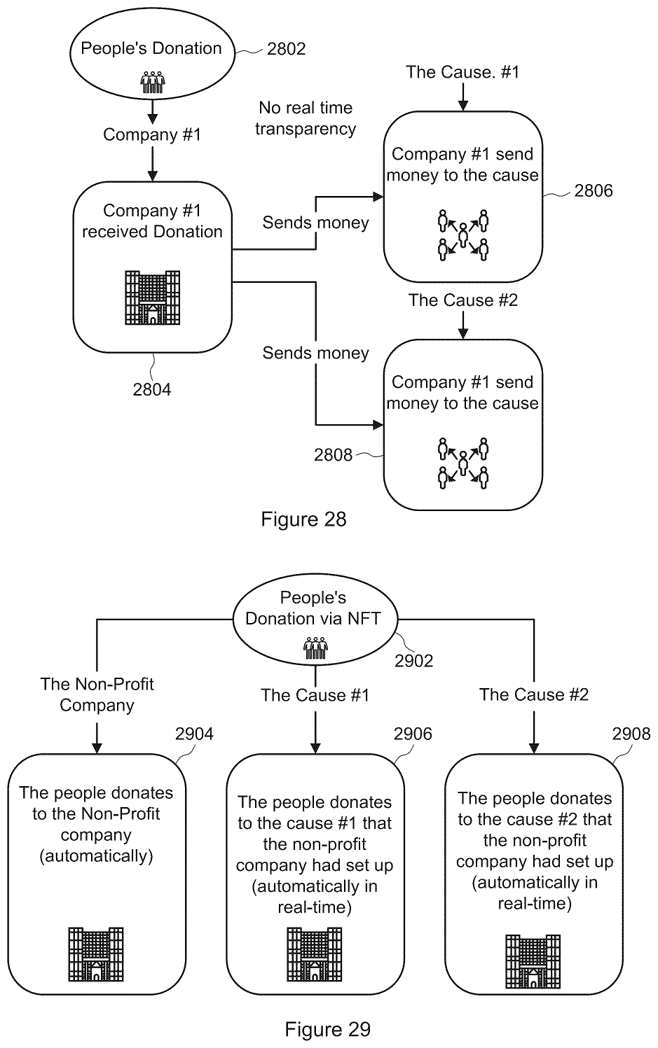

FIG. 28 is diagram illustrating the flow of revenue for a donation of funds to a non-profit organization using a conventional revenue distribution approach. As shown in the figure, in a conventional approach, a person or entity donates 2802 to a company or organization 2804. The organization 2804 then distributes payments to a project or program (referred to as a “Cause” in the figure, where two such Causes 2806 and 2808 are shown as examples). As with the other conventional approaches to payment or royalty distribution described, this involves an intermediary (Company 2804) who is relied upon and trusted to obtain and efficiently redistribute the donation. For one of several reasons, this may not occur or may not occur in an efficient, transparent, and time-sensitive manner.

FIG. 29 is a diagram illustrating the flow of revenue for a donation of funds to a non-profit organization when implemented using an embodiment of the systems and methods disclosed herein. As suggested by the figure, in some embodiments, the role of the intermediary Company in distributing a donation is eliminated and instead the disclosed service platform (not shown) is responsible for transferring donated funds 2902 directly and automatically to the other parties, in this example a Non-Profit Company or Organization 2904, a Cause 2906 (labeled Cause #1 in the figure) and a second Cause 2908 (labeled Cause #2 in the figure). This arrangement reduces the delay in payment of portions of a donation to the appropriate recipient, is performed in a transparent way that is less subject to fraud and provides an audit trail that may be used to ensure all payments have been made and are properly recorded. As suggested by the figure, in an embodiment of the disclosed system or platform, the donation is made by purchase of a NFT that is associated with the type of donation or non-profit organization.

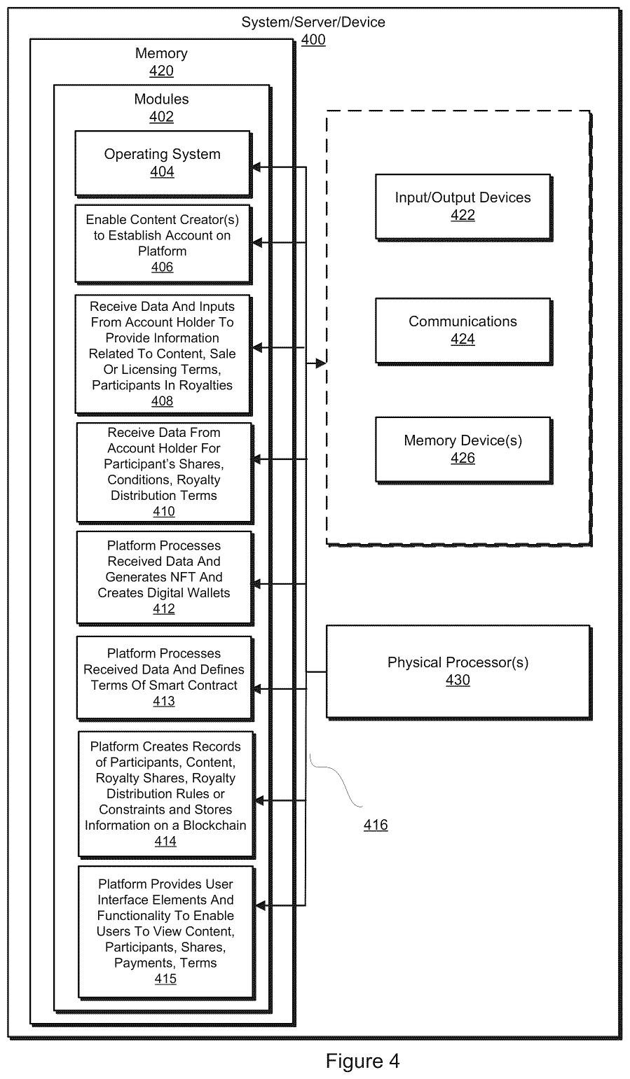

FIG. 4 is a diagram illustrating elements or components that may be present in a computing device or system 400 configured to implement a method, process, function, or operation in accordance with an embodiment of the subject matter disclosed herein. As noted, in some embodiments, the system and methods disclosed may be implemented in the form of an apparatus that includes a processing element and set of executable instructions. The executable instructions may be part of a software application and arranged into a software architecture.

In general, an embodiment may be implemented using a set of software instructions that are designed to be executed by a suitably programmed processing element (a GPU, CPU, TPU, QPU, microprocessor, processor, controller, state machine, or computing device, as examples). In a complex application or system such instructions are typically arranged into “modules” with each such module typically performing a specific task, process, function, or operation. The entire set of modules may be controlled or coordinated in their operation by an operating system (OS) or other form of organizational platform.

Each module or sub-module may correspond to a specific function, method, process, or operation that is implemented by execution of the instructions (in whole or in part) in the module or sub-module. Each module or sub-module may contain a set of computer-executable instructions that when executed by a programmed processor or co-processors cause the processor or co-processors (or a device, devices, server, or servers in which they are contained) to perform the specific function, method, process, or operation. An apparatus in which a processor or co-processor is contained may be one or both of a client device or a remote server or platform. Therefore, a module may contain instructions that are executed (in whole or in part) by the client device, the server or platform, or both.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

The modules may contain one or more sets of instructions for performing a method or function described with reference to the Figures, and the descriptions of the functions and operations provided in this disclosure. These modules may include those illustrated but may also include a greater number or fewer number than those illustrated. As mentioned, each module may contain a set of computer-executable instructions. The set of instructions may be executed by a programmed processor contained in a server, client device, network element, system, platform, or other component.

A module may contain instructions that are executed by a processor contained in more than one of a server, client device, network element, system, platform or other component. Thus, in some embodiments, a plurality of electronic processors, with each being part of a separate device, server, or system may be responsible for executing all or a portion of the software instructions contained in an illustrated module. Although FIG. 4 illustrates a set of modules which taken together perform multiple functions or operations, these functions or operations may be performed by different devices or system elements, with certain of the modules (or instructions contained in those modules) being associated with those devices or system elements.

As shown in FIG. 4, system 400 may represent a server or other form of computing or data processing system, platform, or device. Modules 402 each contain a set of executable instructions, where when the set of instructions is executed by a suitable electronic processor or processors (such as that indicated in the figure by “Physical Processor(s) 430”), system (or server, platform, or device) 400 operates to perform a specific process, operation, function, or method. Modules 402 are stored in a memory 420, which typically includes an Operating System module 404 that contains instructions used (among other functions) to access and control the execution of the instructions contained in other modules. The modules 402 stored in memory 420 are accessed for purposes of transferring data and executing instructions by use of a “bus” or communications line 416, which also serves to permit processor(s) 430 to communicate with the modules for purposes of accessing and executing a set of instructions. Bus or communications line 416 also permits processor(s) 430 to interact with other elements of system 400, such as input or output devices 422, communications elements 424 for exchanging data and information with devices external to system 400, and additional memory devices 426.

A module may contain instructions that when executed (in whole or in part) implement a function, method, process, or operation corresponding to one or more aspects of the disclosed system and methods, such as for:
Enable content creator seller, or representative to establish an account on platform (as suggested by module 406);
Receive data and inputs from account holder to provide information related to one or more of (as suggested by module 408);
   Content type or description;
   Terms Of Sale;
   Terms of Licensing;
   Available Rights;
   Participants in royalties or sharing in revenue generated by content;
      Identifiers, shares, payment constraints or conditions (payment expiration, total to be received) (module 410);
Platform processes received data and information and performs one or more of (modules 412 and 413);
   Generating NFT corresponding to or associated with underlying content;
   Create one or more digital wallets, with one such wallet associated with each person receiving a payment (a participant);
   Define or create smart contract and/or rule-set to determine conditions under which royalty revenue is distributed, to who it is distributed, and in what amount it is distributed to each person or participant involved;
Platform creates record(s) of collaborators, content description, identifiers, royalty payments or shares, or royalty distribution rules or constraints, as examples and stores that information on a blockchain (module 414);
Platform provides user interface elements and functionality to enable a user or category of users to (module 415):
   View description of content;
   View list of creators, collaborators, or participating entities;
   View assigned shares or portions of royalty or other forms of revenue generated by content/NFT;
   Monitor, track, or otherwise examine payments made to each creator, collaborator, or participating entity;
   View totals paid or expected to be paid to each creator, collaborator, or participating entity; or
   View information regarding relevant terms or conditions on NFT/content, such as those incorporated into a smart contract or other form of self-executing logic.

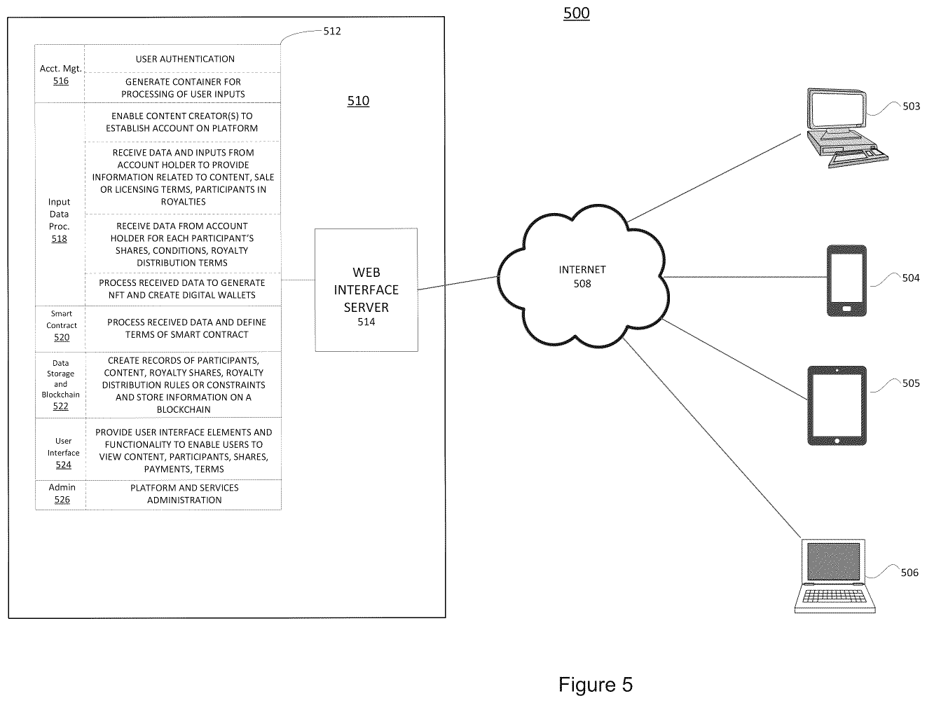

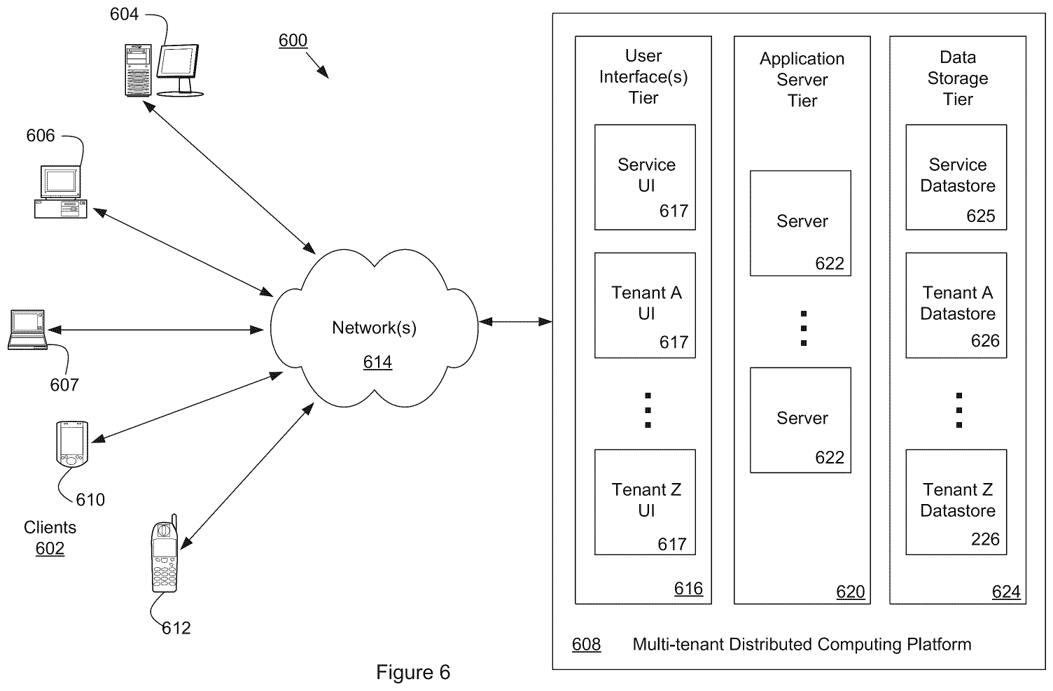

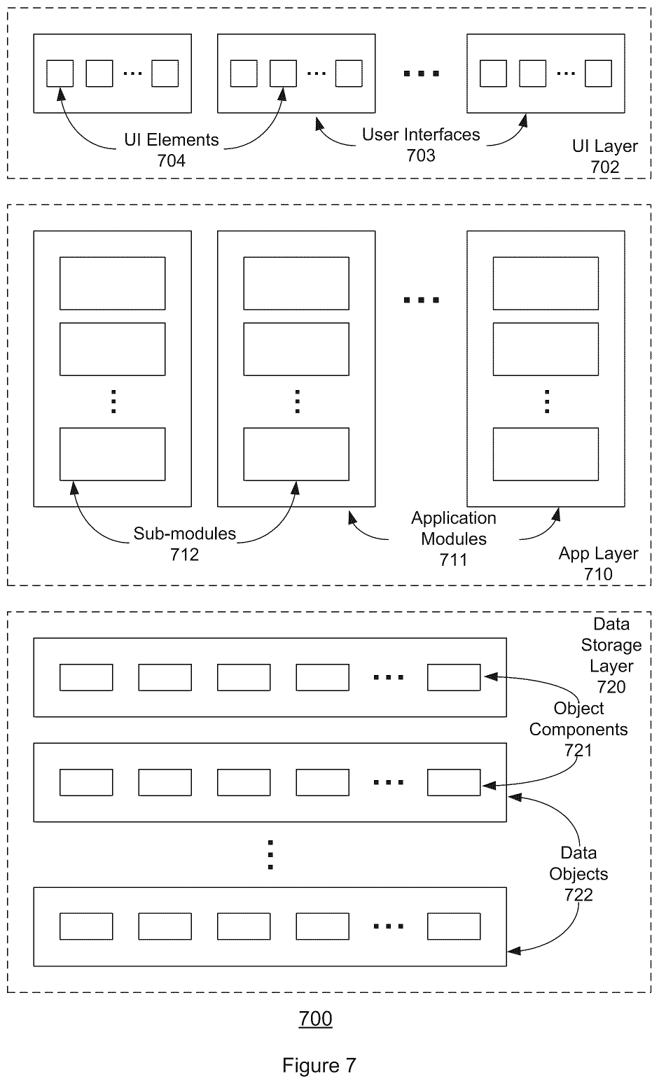

In some embodiments, the functionality and services provided by the system, apparatuses, and methods described herein may be made available to multiple users by accessing an account maintained by a server or service platform. Such a server or service platform may be termed a form of Software-as-a-Service (SaaS). FIGS. 5, 6, and 7 are diagrams illustrating an architecture for a multi-tenant or SaaS platform that may be used in implementing an embodiment of the systems, apparatuses, and methods disclosed herein. FIG. 5 is a diagram illustrating a SaaS system in which an embodiment may be implemented. FIG. 6 is a diagram illustrating elements or components of an example operating environment in which an embodiment may be implemented. FIG. 7 is a diagram illustrating additional details of the elements or components of the multi-tenant distributed computing service platform of FIG. 6, in which an embodiment may be implemented.

In some embodiments, the system or services disclosed herein may be implemented as microservices, processes, workflows or functions performed in response to the submission of a set of input data. The microservices, processes, workflows or functions may be performed by a server, data processing element, platform, apparatus, or system. In some embodiments, the data analysis, inference, and other services may be provided by a service platform located “in the cloud”. In such embodiments, the platform may be accessible through APIs and SDKs. The functions, processes and capabilities disclosed herein and with reference to one or more of the Figures may be provided as microservices within the platform. The interfaces to the microservices may be defined by REST and GraphQL endpoints. An administrative console may allow users or an administrator to securely access the underlying request and response data, manage accounts and access, and in some cases, modify the processing workflow or configuration.

Note that although FIGS. 5, 6, and 7 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide one or more of the methods, processes, services, functions, or capabilities disclosed herein. Although in some embodiments, a platform or system of the type illustrated in the Figures may be operated by a 3rd party provider to provide a specific set of services or applications, in other embodiments, the platform may be operated by a provider and a different entity may provide the applications or services for users through the platform.

FIG. 5 is a diagram illustrating a system 500 in which an embodiment may be implemented or through which an embodiment of the services described herein may be accessed. In accordance with the advantages of an application service provider (ASP) hosted business service system (such as a multi-tenant data processing platform), users of the services described herein may comprise individuals, businesses, or organizations. A user may access the services using any suitable client, including but not limited to desktop computers, laptop computers, tablet computers, or smartphones. In general, any client device having access to the Internet may be used to provide data to the platform for processing and evaluation. A user interfaces with the service platform across the Internet 508 or another suitable communications network or combination of networks. Examples of client devices shown in the figure include desktop computers 503, smartphones 504, tablet computers 505, or laptop computers 506.

System 510, which may be hosted by a third party, may include a set of data analysis and other services to assist in providing the functions and capabilities disclosed herein 512, and a web interface server 514, coupled as shown in FIG. 5. It is to be appreciated that either or both the data analysis and other services 512 and the web interface server 514 may be implemented on one or more different hardware systems and components, even though represented as singular units in FIG. 5.

As non-limiting examples, services 512 may include one or more functions or operations for the submission of content, creation of an NFT corresponding to the content, identification of participants who are to share in the revenue generated from the content and their respective shares, creation or implementation of a smart contract or other decision process to determine how and when to distribute the revenue, create a digital wallet and corresponding identifier for each participant, and provide access to records containing information on royalty or revenue payments and other aspects of the content or revenue distribution.

As examples, in some embodiments, the set of functions, operations or services made available through the platform or system 510 may include:
Account Management services 516, such as
   a process or service to authenticate a user (typically, in conjunction with submission of a user's credentials);
   a process or service to generate a container or instantiation of the services or applications that will be made available to the user;
Input Data Processing services 518, such as
   a process or service to enable content creator(s) to establish an account on the platform;
   a process or service to receive data and inputs from an account holder to provide information related to content, sale or licensing terms, or the participants in royalties, as examples;
   a process or service to receive data from the account holder for each participant's shares, conditions, or royalty distribution terms, as examples;
   a process or service to process the received data to generate an NFT and create one or more digital wallets;
Smart Contract Generation services 520, such as
   a process or service to process the received data and define one or more terms of a smart contract;
Data Storage on Blockchain services 522, such as
   a process or service to create records of participants, content, royalty shares, royalty distribution rules or constraints and store that information on a blockchain;
Generating a User Interface services 524, such as
   a process or service to provide user interface elements and functionality to enable users to view content, participants, shares, payments, or terms, as examples;
Administrative services 526, such as
   a process or services to enable the provider of the services and/or the platform to administer and configure the processes and services provided to users, such as by altering how an NFT is generated, what or how data is stored, example terms for a smart contract, or what additional services or options are provided by the platform, as examples.

The platform or system shown in FIG. 5 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server, as examples. A web server is most often a combination of hardware and the software that helps deliver content, commonly by hosting a website, to client web browsers that access the web server via the Internet.

FIG. 6 is a diagram illustrating elements or components of an example operating environment 600 in which an embodiment may be implemented. As shown, a variety of clients 602 incorporating and/or incorporated into a variety of computing devices may communicate with a multi-tenant service platform 608 through one or more networks 614. For example, a client may incorporate and/or be incorporated into a client application (e.g., software) implemented (executed) at least in part by one or more of the computing devices. Examples of suitable computing devices include personal computers, server computers 604, desktop computers 606, laptop computers 607, notebook computers, tablet computers or personal digital assistants (PDAs) 610, smart phones 612, cell phones, and consumer electronic devices incorporating one or more computing device components (such as one or more electronic processors, microprocessors, central processing units (CPU), or controllers). Examples of suitable networks 614 include networks utilizing wired and/or wireless communication technologies and networks operating in accordance with any suitable networking and/or communication protocol (e.g., the Internet).

The distributed computing service/platform (which may also be referred to as a multi-tenant data processing platform) 608 may include multiple processing tiers, including a user interface tier 616, an application server tier 620, and a data storage tier 624. The user interface tier 616 may maintain multiple user interfaces 617, including graphical user interfaces and/or web-based interfaces. The user interfaces may include a default user interface for the service to provide access to applications and data for a user or “tenant” of the service (depicted as “Service Ul” in the figure), as well as one or more user interfaces that have been specialized/customized in accordance with specific user requirements (e.g., represented by “Tenant A Ul”, . . . , “Tenant Z Ul” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, or causing the execution of specific data processing operations, as examples. Each application server or processing tier 622 shown in the figure may be implemented with a set of computers and/or components including computer servers and processors, and may perform various functions, methods, processes, or operations as determined by the execution of a software application or set of instructions. The data storage tier 624 may include one or more data stores, which may include a Service Data store 625 and one or more Tenant Data stores 626. Data stores may be implemented with any suitable data storage technology, including structured query language (SQL) based relational database management systems (RDBMS).

Service Platform 608 may be multi-tenant and may be operated by an entity to provide multiple tenants with a set of business-related or other data processing applications, data storage, and specific functionality. For example, the applications and functionality may include providing web-based access to the processes used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 622 that are part of the platform's Application Server Tier 620. As noted with regards to FIG. 5, the platform system shown in FIG. 6 may be hosted on a distributed computing system/platform made up of at least one, but typically multiple, “servers.”

As mentioned, rather than build and maintain such a platform or system themselves, a business may utilize systems provided by a third party. A third party may implement a business system/platform as described above in the context of a multi-tenant platform, where individual instantiations of a business' data processing workflow (such as the data analysis and evaluation services and processing described herein) are provided to users, with each business or set of users representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users.

FIG. 7 is a diagram illustrating additional details of the elements or components of the multi-tenant distributed computing service platform of FIG. 6, in which an embodiment may be implemented. The software architecture shown in FIG. 7 represents an example of an architecture which may be used to implement an embodiment. In general, an embodiment may be implemented using a set of software instructions that are designed to be executed by a suitably programmed processing element (such as a CPU, microprocessor, processor, controller, or computing device, as examples). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 7 is a diagram illustrating additional details of the elements or components 700 of a multi-tenant distributed computing service platform, in which an embodiment may be implemented. The example architecture includes a user interface layer or tier 702 having one or more user interfaces 703. Examples of such user interfaces include graphical user interfaces and application programming interfaces (APIs). Each user interface may include one or more interface elements 704. Users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 710 may include one or more application modules 711, each having one or more sub-modules 712. Each application module 711 or sub-module 712 may correspond to a function, method, process, or operation that is implemented by the module or sub-module (e.g., a function or process related to providing data processing and services to a user of the platform). Such function, method, process, or operation may include those used to implement one or more aspects of the disclosed system and methods, such as for one or more of the processes or functions described with reference to the Figures:
Enable content creator seller, or representative to establish an account on a platform;
Receive data and inputs from account holder to provide information related to one or more of;
   Content type or description;
   Terms Of Sale;
   Terms of Licensing;
   Available Rights;
   Participants in royalties or sharing in revenue generated by content;
      Identifiers, shares, payment constraints or conditions (payment expiration, total to be received);
Enable platform to process received data and information and perform one or more of;
   Generating NFT corresponding to or associated with underlying content;
   Create one or more digital wallets, with one such wallet associated with each person receiving a payment (a participant);
   Define or create smart contract and/or rule-set to determine conditions under which royalty revenue is distributed, to who it is distributed, and in what amount it is distributed to each person or participant involved;
Enable platform to create record(s) of collaborators, content description, identifiers, royalty payments or shares, or royalty distribution rules or constraints, as examples and stores that information on a blockchain;
Generate user interface elements and functionality to enable a user or category of users to:
   View description of content;
   View list of creators, collaborators, or participating entities;
   View assigned shares or portions of royalty or other forms of revenue generated by content/NFT;
   Monitor, track, or otherwise examine payments made to each creator, collaborator, or participating entity;
   View totals paid or expected to be paid to each creator, collaborator, or participating entity; or
   View information regarding relevant terms or conditions on NFT/content, such as those incorporated into a smart contract or other form of self-executing logic.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 622 of FIG. 6) may include each application module. Alternatively, different application servers may include different sets of application modules. Such sets may be disjoint or overlapping.

The data storage layer 720 may include one or more data objects 722 each having one or more data object components 721, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 5, 6, and 7 are not intended to be limiting examples. Further environments in which an embodiment may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

Embodiments of the disclosure may be implemented in the form of control logic using computer software in a modular or integrated manner. Based on the disclosure and teachings provided herein, a person of ordinary skill in the art will recognize other ways and/or methods to implement an embodiment using hardware, software, or a combination of hardware and software.

The disclosure includes the following clauses and embodiments:

1. A method of distributing revenue from a collaborative project, comprising:
receiving data from a user regarding a project and terms of a sale or licensing of content generated by the project;
processing the received data to generate a token representing the content, and to create one or more digital wallets, with one wallet created for each party that is identified by the user as being involved in a collaboration that generated the content;
processing the received data to generate a smart contract, the smart contract including a clause defining a state or condition that automatically results in an executed action;
distributing a portion of payments or revenue received from the sale, distribution, exhibition, or licensing of the content to one or more of the digital wallets, wherein the distribution is determined by the clause of the smart contract;
creating one or more records stored on a blockchain, the records including data regarding the payments or revenue received, and the party or parties to which the payments or revenue received have been distributed; and
creating a user interface, wherein the user interface includes elements to enable the user to perform one or more of browsing, selecting, or previewing available content, accessing pricing for content, submitting a bid or offer for a right to content, viewing the payments or revenue generated by an item of content and how it has been distributed, or viewing a transaction history of the content.

2. The method of clause 1, wherein the content is one of an image, an audio track, a photograph, a composition, a recording, a manufactured item, an original work of art, a literary work, a motion picture, or a television program.

3. The method of clause 1, wherein the content is a collaboratively produced item, product, or service offering in which multiple people contribute a portion of a complete service, an assembly service step, a license to underlying intellectual property, or a packaging step.

4. The method of clause 1, wherein the data received from the user comprises one or more of:
an initial sale price for the content;
a description of how payments or royalties are to be distributed to the collaborators in the project;
the names or identifiers for each collaborator that is to receive a portion of the sale price, royalties, or other form of payments for the content; or
relevant licensing conditions or terms that create an obligation to make a royalty payment or generate revenue to be distributed.

5. The method of clause 1, wherein the smart contract comprises a clause or term that when executed results in one or more of payment for the sale of the token, or payment for the licensing of a right or rights to the content.

6. The method of clause 5, wherein the licensed right or rights comprise one or more of:
a license to distribute the content in a market, geographical region, or location;
a license to exhibit the content in a market, geographical location, or type of setting;
a right to sub-license use of the content;
a license to permit manufacture or use of a protected technique or device;
a license to permit creation of a derivative work;
a license to permit acquisition of franchising rights; or
a license to permit reselling of a protected right, product, or service.

7. The method of clause 1, wherein the token is a non-fungible token (NFT).

8. A system for distributing revenue from a collaborative project, comprising:
one or more electronic processors;
a memory or data storage element including a set of computer-executable instructions that, when executed by the one or more electronic processors, cause the system to
   receive data from a user regarding a project and terms of a sale or licensing of content generated by the project;
   process the received data to generate a token representing the content, and to create one or more digital wallets, with one wallet created for each party that is identified by the user as being involved in a collaboration that generated the content;
   process the received data to generate a smart contract, the smart contract including a clause defining a state or condition that automatically results in an executed action;
   distribute a portion of payments or revenue received from the sale, distribution, exhibition, or licensing of the content to one or more of the digital wallets, wherein the distribution is determined by the clause of the smart contract;
   create one or more records stored on a blockchain, the records including data regarding the payments or revenue received, and the party or parties to which the payments or revenue received have been distributed; and
   create a user interface, wherein the user interface includes elements to enable the user to perform one or more of browsing, selecting, or previewing available content, accessing pricing for content, submitting a bid or offer for a right to content, viewing the payments or revenue generated by an item of content and how it has been distributed, or viewing a transaction history of the content.

9. The system of clause 8, wherein the content is one of an image, an audio track, a photograph, a composition, a recording, a manufactured item, an original work of art, a literary work, a motion picture, or a television program.

10. The system of clause 8, wherein the content is a collaboratively produced item, product, or service offering in which multiple people contribute a portion of a complete service, an assembly service step, a license to underlying intellectual property, or a packaging step.

11. The system of clause 8, wherein the data received from the user comprises one or more of:
an initial sale price for the content;
a description of how payments or royalties are to be distributed to the collaborators in the project;
the names or identifiers for each collaborator that is to receive a portion of the sale price, royalties, or other form of payments for the content; or

relevant licensing conditions or terms that create an obligation to make a royalty payment or generate revenue to be distributed.

12. The system of clause 8, wherein the smart contract comprises a clause or term that when executed results in one or more of payment for the sale of the token, or payment for the licensing of a right or rights to the content.

13. The system of clause 12, wherein the licensed right or rights comprise one or more of:
a license to distribute the content in a market, geographical region, or location;
a license to exhibit the content in a market, geographical location, or type of setting;
a right to sub-license use of the content;
a license to permit manufacture or use of a protected technique or device;
a license to permit creation of a derivative work;
a license to permit acquisition of franchising rights; or
a license to permit reselling of a protected right, product, or service.

14. The system of clause 8, wherein the token is a non-fungible token (NFT).

15. One or more non-transitory computer-readable media comprising a set of computer-executable instructions that when executed by one or more programmed electronic processors, cause the processors to:
receive data from a user regarding a project and terms of a sale or licensing of content generated by the project;
process the received data to generate a token representing the content, and to create one or more digital wallets, with one wallet created for each party that is identified by the user as being involved in a collaboration that generated the content;
process the received data to generate a smart contract, the smart contract including a clause defining a state or condition that automatically results in an executed action;
distribute a portion of payments or revenue received from the sale, distribution, exhibition, or licensing of the content to one or more of the digital wallets, wherein the distribution is determined by the clause of the smart contract;
create one or more records stored on a blockchain, the records including data regarding the payments or revenue received, and the party or parties to which the payments or revenue received have been distributed; and
create a user interface, wherein the user interface includes elements to enable the user to perform one or more of browsing, selecting, or previewing available content, accessing pricing for content, submitting a bid or offer for a right to content, viewing the payments or revenue generated by an item of content and how it has been distributed, or viewing a transaction history of the content.

16. The one or more non-transitory computer-readable media of clause 15, wherein the content is one of an image, an audio track, a photograph, a composition, a recording, a manufactured item, an original work of art, a literary work, a motion picture, or a television program.

17. The one or more non-transitory computer-readable media of clause 15, wherein the content is a collaboratively produced item, product, or service offering in which multiple people contribute a portion of a complete service, an assembly service step, a license to underlying intellectual property, or a packaging step.

18. The one or more non-transitory computer-readable media of clause 15, wherein the data received from the user comprises one or more of:
an initial sale price for the content;
a description of how payments or royalties are to be distributed to the collaborators in the project;
the names or identifiers for each collaborator that is to receive a portion of the sale price, royalties, or other form of payments for the content; or
relevant licensing conditions or terms that create an obligation to make a royalty payment or generate revenue to be distributed.

19. The one or more non-transitory computer-readable media of clause 15, wherein the smart contract comprises a clause or term that when executed results in one or more of payment for the sale of the token, or payment for the licensing of a right or rights to the content.

20. The one or more non-transitory computer-readable media of clause 19, wherein the licensed right or rights comprise one or more of:
a license to distribute the content in a market, geographical region, or location;
a license to exhibit the content in a market, geographical location, or type of setting;
a right to sub-license use of the content;
a license to permit manufacture or use of a protected technique or device;
a license to permit creation of a derivative work;
a license to permit acquisition of franchising rights; or
a license to permit reselling of a protected right, product, or service.

21. The one or more non-transitory computer-readable media of clause 15, wherein the token is a non-fungible token (NFT).

Any of the software components, processes or functions described in this application may be implemented as software code to be executed by a processor using any suitable computer language such as Python, Java, JavaScript, C++, or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network. Further, the set of instructions may be conveyed to a user through a transfer of instructions or an application that executes a set of instructions (such as over a network, e.g., the Internet). The set of instructions or an application may be utilized by an end-user through access to a SaaS platform or a service provided through such a platform.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HDDVD) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of all examples, or exemplary language (e.g., “such as”) provided herein, is intended merely to better illuminate embodiments of the disclosure, and does not pose a limitation to the scope unless otherwise claimed. No language in the specification should be construed as indicating any non-claimed element as essential to each embodiment of the disclosure.

As used herein in the specification, figures, and claims, the term “or” is used inclusively to refer items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this disclosure. Accordingly, the disclosure is not limited to the embodiments described above or depicted in the drawings, and various embodiments and modifications can be made without departing from the scope of the claims below.

That which is claimed is:

1. A method of distributing revenue from a collaborative project, comprising:
receiving data from a user regarding a project and terms of a sale or licensing of content generated by the project;
processing the received data to generate a token representing the content, and to create one or more digital wallets, with one wallet created for each party that is identified by the user as being involved in a collaboration that generated the content;
processing the received data to generate a smart contract, the smart contract including a clause defining a state or condition that automatically results in an executed action;
distributing a portion of payments or revenue received from the sale, distribution, exhibition, or licensing of the content to one or more of the digital wallets, wherein the distribution is determined by the clause of the smart contract;
creating one or more records stored on a blockchain, the records including data regarding the payments or revenue received, and the party or parties to which the payments or revenue received have been distributed; and
creating a user interface, wherein the user interface includes elements to enable the user to perform one or more of browsing, selecting, or previewing available content, accessing pricing for content, submitting a bid or offer for a right to content, viewing the payments or revenue generated by an item of content and how it has been distributed, or viewing a transaction history of the content.

2. The method of claim 1, wherein the content is one of an image, an audio track, a photograph, a composition, a recording, a manufactured item, an original work of art, a literary work, a motion picture, or a television program.

3. The method of claim 1, wherein the content is a collaboratively produced item, product, or service offering in which multiple people contribute a portion of a complete service, an assembly service step, a license to underlying intellectual property, or a packaging step.

4. The method of claim 1, wherein the data received from the user comprises one or more of:
an initial sale price for the content;
a description of how payments or royalties are to be distributed to the collaborators in the project;
the names or identifiers for each collaborator that is to receive a portion of the sale price, royalties, or other form of payments for the content; or
relevant licensing conditions or terms that create an obligation to make a royalty payment or generate revenue to be distributed.

5. The method of claim 1, wherein the smart contract comprises a clause or term that when executed results in one or more of payment for the sale of the token, or payment for the licensing of a right or rights to the content.

6. The method of claim 5, wherein the licensed right or rights comprise one or more of:
a license to distribute the content in a market, geographical region, or location;
a license to exhibit the content in a market, geographical location, or type of setting;
a right to sub-license use of the content;
a license to permit manufacture or use of a protected technique or device;
a license to permit creation of a derivative work;
a license to permit acquisition of franchising rights; or
a license to permit reselling of a protected right, product, or service.

7. The method of claim 1, wherein the token is a non-fungible token (NFT).

8. A system for distributing revenue from a collaborative project, comprising:
one or more electronic processors;
an electronic non-transitory data storage element including a set of computer-executable instructions that, when executed by the one or more electronic processors, cause the system to
receive data from a user regarding a project and terms of a sale or licensing of content generated by the project;
process the received data to generate a token representing the content, and to create one or more digital wallets, with one wallet created for each party that is identified by the user as being involved in a collaboration that generated the content;
process the received data to generate a smart contract, the smart contract including a clause defining a state or condition that automatically results in an executed action;
distribute a portion of payments or revenue received from the sale, distribution, exhibition, or licensing of the content to one or more of the digital wallets, wherein the distribution is determined by the clause of the smart contract;
create one or more records stored on a blockchain, the records including data regarding the payments or revenue received, and the party or parties to which the payments or revenue received have been distributed; and
create a user interface, wherein the user interface includes elements to enable the user to perform one or more of browsing, selecting, or previewing available content, accessing pricing for content, submitting a bid or offer for a right to content, viewing the payments or revenue generated by an item of content and how it has been distributed, or viewing a transaction history of the content.

9. The system of claim 8, wherein the content is one of an image, an audio track, a photograph, a composition, a recording, a manufactured item, an original work of art, a literary work, a motion picture, or a television program.

10. The system of claim 8, wherein the content is a collaboratively produced item, product, or service offering in which multiple people contribute a portion of a complete service, an assembly service step, a license to underlying intellectual property, or a packaging step.

11. The system of claim 8, wherein the data received from the user comprises one or more of:
an initial sale price for the content;
a description of how payments or royalties are to be distributed to the collaborators in the project;
the names or identifiers for each collaborator that is to receive a portion of the sale price, royalties, or other form of payments for the content; or
relevant licensing conditions or terms that create an obligation to make a royalty payment or generate revenue to be distributed.

12. The system of claim 8, wherein the smart contract comprises a clause or term that when executed results in one or more of payment for the sale of the token, or payment for the licensing of a right or rights to the content.

13. The system of claim 12, wherein the licensed right or rights comprise one or more of:
a license to distribute the content in a market, geographical region, or location;
a license to exhibit the content in a market, geographical location, or type of setting;
a right to sub-license use of the content;
a license to permit manufacture or use of a protected technique or device;
a license to permit creation of a derivative work;
a license to permit acquisition of franchising rights; or
a license to permit reselling of a protected right, product, or service.

14. The system of claim 8, wherein the token is a non-fungible token (NFT).

15. One or more non-transitory computer-readable media comprising a set of computer-executable instructions that when executed by one or more programmed electronic processors, cause the processors to:
receive data from a user regarding a project and terms of a sale or licensing of content generated by the project;
process the received data to generate a token representing the content, and to create one or more digital wallets, with one wallet created for each party that is identified by the user as being involved in a collaboration that generated the content;
process the received data to generate a smart contract, the smart contract including a clause defining a state or condition that automatically results in an executed action;
distribute a portion of payments or revenue received from the sale, distribution, exhibition, or licensing of the content to one or more of the digital wallets, wherein the distribution is determined by the clause of the smart contract;
create one or more records stored on a blockchain, the records including data regarding the payments or revenue received, and the party or parties to which the payments or revenue received have been distributed; and
create a user interface, wherein the user interface includes elements to enable the user to perform one or more of browsing, selecting, or previewing available content, accessing pricing for content, submitting a bid or offer for a right to content, viewing the payments or revenue generated by an item of content and how it has been distributed, or viewing a transaction history of the content.

16. The one or more non-transitory computer-readable media of claim 15, wherein the content is one of an image, an audio track, a photograph, a composition, a recording, a manufactured item, an original work of art, a literary work, a motion picture, or a television program.

17. The one or more non-transitory computer-readable media of claim 15, wherein the content is a collaboratively produced item, product, or service offering in which multiple people contribute a portion of a complete service, an assembly service step, a license to underlying intellectual property, or a packaging step.

18. The one or more non-transitory computer-readable media of claim 15, wherein the data received from the user comprises one or more of:
an initial sale price for the content;
a description of how payments or royalties are to be distributed to the collaborators in the project;
the names or identifiers for each collaborator that is to receive a portion of the sale price, royalties, or other form of payments for the content; or
relevant licensing conditions or terms that create an obligation to make a royalty payment or generate revenue to be distributed.

19. The one or more non-transitory computer-readable media of claim 15, wherein the smart contract comprises a clause or term that when executed results in one or more of payment for the sale of the token, or payment for the licensing of a right or rights to the content.

20. The one or more non-transitory computer-readable media of claim 19, wherein the licensed right or rights comprise one or more of:
a license to distribute the content in a market, geographical region, or location;
a license to exhibit the content in a market, geographical location, or type of setting;
a right to sub-license use of the content;
a license to permit manufacture or use of a protected technique or device;
a license to permit creation of a derivative work;
a license to permit acquisition of franchising rights; or
a license to permit reselling of a protected right, product, or service.

21. The one or more non-transitory computer-readable media of claim 15, wherein the token is a non-fungible token (NFT).
